(19) United States
(12) Patent Application Publication
(10) Pub. No.: US 2023/0056801 A1
(43) Pub. Date: Feb. 23, 2023

(54) Electrophotographic Photoreceptor, Electrophotographic Photoreceptor Cartridge, and Image Forming Device

(71) Applicant: Mitsubishi Chemical Corporation, Tokyo (JP)

(72) Inventors: Takahiro Choda, Tokyo (JP); Akira Ando, Tokyo (JP)

(73) Assignee: Mitsubishi Chemical Corporation, Tokyo (JP)

(21) Appl. No.: 17/955,438

(22) Filed: Sep. 28, 2022

Related U.S. Application Data
(63) Continuation of application No. PCT/JP2021/013646, filed on Mar. 30, 2021.

(30) Foreign Application Priority Data
Mar. 31, 2020 (JP) 2020-064012

(51) Int. Cl. G03G 5/147; G03G 5/047; G03G 5/06; G03G 21/18

(52) U.S. Cl. CPC G03G 5/14734; G03G 5/047; G03G 5/0609; G03G 5/061446; G03G 5/14704; G03G 5/06142; G03G 21/1814

(57) ABSTRACT

As a new negatively charging electrophotographic photoconductor having a cured resin based protective layer that does not necessitate a heat treatment for enhancing the electric characteristics, a negatively charging electrophotographic photoconductor having a structure including a photosensitive layer and a protective layer containing a cured product formed by curing a curable compound on a conductive support in this order, the photosensitive layer containing at least a hole transporting material (HTM) and a radical acceptor compound or an electron transporting material (ETM), the hole transporting material (HTM) being a compound having an energy difference between a HOMO level and a LUMO level of 3.60 eV or less, and having a HOMO level of −4.50 eV or less based on the vacuum level is proposed.

### TECHNICAL FIELD

The present invention relates to an electrophotographic photoconductor, an electrophotographic photoconductor cartridge, and an image formation device, used in duplicators, printers, and the like.

### BACKGROUND ART

In printers, duplicators, and the like, a charged organic photoconductor (OPC) drum is irradiated with light to form an electrostatic latent image through destaticization of the irradiated part, and a tonner is attached to the electrostatic latent image to provide an image. In the devices using the electrophotographic technology the photoconductor is the basic member, as described above.

The organic photoconductor of this type has a wide range of material option, and a “functional separation type photoconductor” in which the functions of generation and transportation of negative charge are shared by separate compounds is becoming the mainstream since the characteristics of the photoconductor can be easily controlled. For example, a single layer type electrophotographic photoconductor containing a charge generating material (CGM) and a charge transporting material (CTM) in one layer (which may be hereinafter referred to as a single layer type photoconductor), and a laminate type electrophotographic photoconductor including a charge generating layer containing a charge generating material (CGM) and a charge transporting layer containing a charge transporting material (CTM) laminated on each other (which may be hereinafter referred to as a laminate type photoconductor) have been known. Examples of the charge system of the photoconductor include a negative charge system in which the photoconductor surface is negatively charged, and a positive charge system in which the photoconductor surface is positively charged.

Examples of the currently available combination of the layer structure of the photoconductor and the charge system include a “negatively charging laminate type photoconductor” and a “positively charging single layer type photoconductor”.

The “negatively charging laminate type photoconductor” generally has a configuration including a conductive support, such as an aluminum pipe, having an undercoating layer (UCL) formed of a resin or the like provided thereon, a charge generating layer (CGL) formed of a charge generating material (CGM), a resin, and the like provided thereon, and a charge transporting layer (CTL) formed of a hole transporting material (HTM), a resin, and the like further formed thereon.

In the negatively charging laminate type photoconductor, the surface of the photoconductor is negatively charged by a corona discharge system or a contact system, and then the photoconductor is exposed to light. The charge generating material (CGM) absorbs the light to form charge carriers including holes and electrons, and between these, the holes, i.e., the positive charge carriers, migrate in the charge transporting layer (CTL) through the hole transporting material (HTM), and reach the photoconductor surface to neutralize the surface charge. On the other hand, the electrons, i.e., the negative charge carrier, generated in the charge generating material (CGM) pass through the undercoating layer (UCL) and reach the conductive support. In the negatively charging laminate type photoconductor, as described herein, what migrate mainly in the photosensitive layer are holes, and therefore only a hole transporting material is generally contained as the charge transporting material in the photosensitive layer. At this time, in the case where a compound having a small hole transporting capability, such as an electron transporting material, is further added, the content of the hole transporting material in the photosensitive layer is decreased to cause a problem of deterioration of the electric characteristics. Furthermore, the content of the binder resin is also decreased thereby to cause a concern of decrease of the abrasion resistance. Accordingly, an electron transporting material has not been added to the photosensitive layer except for special cases.

The “positively charging single layer type photoconductor” generally has a configuration including a conductive support, such as an aluminum pipe, having an undercoating layer (UCL) formed of a resin or the like provided thereon, and a single photosensitive layer containing a charge generating material (CGM), a hole transporting material (HTM), an electron transporting material (ETM), a resin, and the like further formed thereon (see, for example, PTL 1).

In the positively charging single layer type photoconductor, the surface of the photoconductor is positively charged by a corona discharge system or a contact system, and then the photoconductor is exposed to light. The charge generating material (CGM) in the vicinity of the photosensitive layer surface absorbs the light to form charge carriers including holes and electrons, and between these, the electrons, i.e., the negative charge carriers, neutralize the surface charge on the photosensitive layer surface. On the other hand, the holes, i.e., the positive charge carriers, generated in the charge generating material (CGM) pass through the photosensitive layer and the undercoating layer (UCL) and reach the conductive support.

In both the photoconductors, the surface charge of the photoconductor is neutralized to form an electrostatic latent image through the difference in potential from the surrounding surface, and thereafter, printing is completed through visualization of the latent image with a toner (i.e., a powder colored resin ink), and transfer and melt fixing under heat of the toner to paper or the like.

As described above, the electrophotographic photoconductor has the basic structure including a conductive support having a photosensitive layer formed thereon, and a protective layer may be formed on the photosensitive layer for the purpose of improving the abrasion resistance and the like.

For example, PTL 1 describes that a surface protective layer containing a thermoplastic alcohol soluble resin as a binder resin and a filler having an average primary particle diameter of 0.1 to 3 μm and a density of 3.0 g/cm³ or less is provided as the outermost surface layer on the photosensitive layer.

PTL 2 describes that a crosslinking type surface layer formed by curing, by heat or light, a composition containing a trimethylolpropane acrylate crosslinked product, an organosilica cured film, and a composition containing a thermally curable or photocurable crosslinking material is provided on the photosensitive layer.

PTL 3 describes that a surface protective layer is provided on the surface side of a photosensitive layer, and the surface protective layer is a cured product formed by photocuring a composition containing a hindered amine compound, a polymerizable compound for a binder, and a charge transporting agent.

### CITATION LIST

### Patent Literatures

PTL 1: JP 2014-163984 A
PTL 2: JP 2008-26689 A
PTL 3: JP 2019-35856 A

### SUMMARY OF INVENTION

### Technical Problem

As a result of the investigation by the present inventors, it has been found that in the case where a negatively charging photoconductor having a cured resin based protective layer contains a particular hole transporting material (HTM) in the photosensitive layer, the enhancement of the ozone resistance and the strong exposure characteristics is expected, but a problem of deterioration of the electric characteristics occurs.

As a result of the further investigation by the present inventors, it has been found that the problem of deterioration of the electric characteristics can be ameliorated by performing a heat treatment of the protective layer immediately after curing, but in the case where the heat treatment is performed, the site for the heat treatment process, the heating device, and the like are necessarily introduced, which results in a new problem of increase of the initial cost and increase of the running cost.

As a result of the investigation by the present inventors, the positively charging photoconductor does not suffer the problem described above occurring in the case where the photosensitive layer contains the particular hole transporting material (HTM) even though the cured resin based protective layer is provided.

An object of the present invention is to provide a negatively charging electrophotographic photoconductor having a cured resin based protective layer that has good electric characteristics while the photosensitive layer contains a particular hole transporting material (HTM).

### Solution to Problem

The present invention proposes a negatively charging electrophotographic photoconductor having a structure including a photosensitive layer and a protective layer containing a cured product formed by curing a curable compound (which may be referred to as a “cured resin based protective layer”) on a conductive support in this order, the curable compound being a photocurable compound, the photosensitive layer containing a hole transporting material (HTM), the hole transporting material (HTM) being a compound having an energy difference between a HOMO level and a LUMO level of 3.60 eV or less, and having the HOMO level of −4.50 eV or less based on the vacuum level, the photosensitive layer further containing a radical acceptor compound having an electron affinity of 3.50 eV or more or an electron transporting material (ETM).

Specifically, the substance of the present invention resides in the following items [1] to [13].

[1] A negatively charging electrophotographic photoconductor having a structure including a photosensitive layer and a protective layer containing a cured product formed by curing a curable compound on the conductive support in this order,

the curable compound being a photocurable compound,

the photosensitive layer containing a hole transporting material (HTM),

the hole transporting material (HTM) being a compound having an energy difference between a HOMO level and a LUMO level of 3.60 eV or less, and having a HOMO level of −4.50 eV or less based on the vacuum level,

the photosensitive layer further containing a radical acceptor compound having an electron affinity of 3.50 eV or more.

[2] A negatively charging electrophotographic photoconductor having a structure including a photosensitive layer and a protective layer containing a cured product formed by curing a curable compound on the conductive support in this order,

the curable compound being a photocurable compound,

the photosensitive layer containing a hole transporting material (HTM),

the hole transporting material (HTM) being a compound having an energy difference between a HOMO level and a LUMO level of 3.60 eV or less, and having a HOMO level of −4.50 eV or less based on the vacuum level,

the photosensitive layer further containing an electron transporting material (ETM).

[3] The negatively charging electrophotographic photoconductor according to the item [1] or [2], wherein the photocurable compound is a compound having an acryloyl group or a methacryloyl group.

[4] The negatively charging electrophotographic photoconductor according to any one of the items [1] to [3], wherein the protective layer is a layer formed with a composition containing the photocurable compound and a polymerization initiator.

[5] The negatively charging electrophotographic photoconductor according to any one of the items [1] to [4], wherein the photosensitive layer is a laminate type photosensitive layer having a structure including a charge generating layer (CGL) containing a charge generating material (CGM), having laminated thereon a charge transporting layer (CTL) containing the hole transporting material (HTM) and the radical acceptor compound having an electron affinity of 3.50 eV or more or the electron transporting material (ETM).

[6] The negatively charging electrophotographic photoconductor according to any one of the items [1] to [5], wherein the negatively charging electrophotographic photoconductor has a Martens hardness of 270 N/mm² or more.

[7] The negatively charging electrophotographic photoconductor according to any one of the items [1] to [6], wherein the radical acceptor compound or the electron transporting material (ETM) is a compound having a diphenoquinone structure or a dinaphthylquinone structure.

[8] The negatively charging electrophotographic photoconductor according to any one of the items [1] to [7], wherein the photosensitive layer has a content of the radical acceptor compound or the electron transporting material (ETM) of 0.1 part by mass to 10 parts by mass per 100 parts by mass of the hole transporting material (HTM) in the photosensitive layer.

[9] The negatively charging electrophotographic photoconductor according to any one of the items [1] to [8], wherein the hole transporting material (HTM) in the photosensitive layer is a compound having a triphenylamine structure.

[10] The negatively charging electrophotographic photoconductor according to any one of the items [1] to [9], wherein the protective layer further contains metal oxide particles, and the metal oxide particles have a band gap that is smaller than the energy difference between the HOMO level and the LUMO level of the HTM of the photosensitive layer.

[11] The negatively charging electrophotographic photoconductor according to any one of the items [1] to [10], wherein the protective layer is a layer formed by curing through irradiation of ultraviolet light and/or visible light.

[12] A cartridge including the negatively charging electrophotographic photoconductor according to any one of the items [1] to [11].

An image formation device including the negatively charging electrophotographic photoconductor according to any one of the items [1] to [11].

### Advantageous Effects of Invention

In a negatively charging electrophotographic photoconductor having a structure including a photosensitive layer and a cured resin based protective layer on the conductive support in this order, it has been found that in the case where the curable compound is a photocurable compound, and the photosensitive layer contains a hole transporting material (HTM) satisfying the prescribed condition, the electric characteristics can be improved in such a manner that the photosensitive layer further contains a radical acceptor compound having an electron affinity of 3.50 eV or more or an electron transporting material (ETM). In this case, the hole transporting material (HTM) satisfying the prescribed condition means the case where the hole transporting material (HTM) is a compound having an energy difference between a HOMO level and a LUMO level of 3.60 eV or less, and having a HOMO level of −4.50 eV or less based on the vacuum level.

### BRIEF DESCRIPTION OF THE DRAWING

FIG. 1 is an illustration schematically showing a configuration example of an image formation device capable of being constituted by using an electrophotographic photoconductor according to one example of the present invention.

### DESCRIPTION OF EMBODIMENTS

The present invention will be described with reference to embodiments below. However, the present invention is not limited to the embodiments described below.

<<Present Electrophotographic Photoconductor>>

An electrophotographic photoconductor according to one example of an embodiment of the present invention (which may be referred to as a “present electrophotographic photoconductor” or a “present photoconductor”) is a negatively charging electrophotographic photoconductor having a structure including a photosensitive layer containing at least a hole transporting material (HTM) and a radical acceptor compound having an electron affinity of 3.50 eV or more (which may be hereinafter referred simply to as the “radical acceptor compound”) or an electron transporting material (ETM), and a cured resin based protective layer containing a cured product formed by curing a curable compound (which may be referred to as a “present protective layer”) on the conductive support in this order.

The present photoconductor may optionally include other layers than the photosensitive layer and the present protective layer.

In the photoconductor of the present invention, the opposite side to the conductive support is referred to as an upper side or a front surface side, and the side of the conductive support is referred to as a lower side or a back surface side.

<Photosensitive Layer>

The photosensitive layer in the present photoconductor may be a single layer type photosensitive layer having a charge generating material (CGM), the hole transporting material (HTM), and the radical acceptor compound having an electron affinity of 3.50 eV or more or the electron transporting material (ETM) existing in one layer, or a laminate type photosensitive layer including a charge generating layer and a charge transporting layer separated from each other, as far as the photosensitive layer contains at least the hole transporting material (HTM) and the radical acceptor compound or the electron transporting material (ETM). Between these, a laminate type photosensitive layer described below is more preferred.

<Laminate Type Photosensitive Layer>

Examples of the laminate type photosensitive layer in the present photoconductor include a configuration including a charge generating layer (CGL) containing a charge generating material (CGM), having laminated thereon a charge transporting layer (CTL) containing a hole transporting material (HTM) and the radical acceptor compound or the electron transporting material (ETM). In this case, other layers than the charge generating layer (CGL) and the charge transporting layer (CTL) may be included.

<Charge Generating Layer (CGL)>

It suffices that the charge generating layer contains a charge generating material (CGM) and a binder resin.

(Charge Generating Material (CGM))

Examples of the charge generating material include an inorganic photoconductive material, such as selenium and an alloy thereof, and cadmium sulfide, and an organic photoconductive material, such as an organic pigment. Among these, an organic photoconductive material is preferred, and an organic pigment is particularly preferred.

Examples of the organic pigment include phthalocyanine, azo, dithioketopyrrolopyrrole, squalene (squalirium), quinacridone, indigo, perylene, polycyclic quinone, anthanthrone, and benzimidazole. Among these, phthalocyanine and azo are preferred. Between these, phthalocyanine is most preferred. These terms show skeletal structures of compounds, and each encompasses a group of compounds having the skeletal structure, i.e., derivatives.

In the case where an organic pigment is used as the charge generating material, a dispersion layer containing fine particles of the organic pigment bound with various binder resins is generally used.

Specific examples of the phthalocyanine include metal-free phthalocyanine, a phthalocyanine compound having various crystal forms having coordinated thereto a metal, such as copper, indium, gallium, tin, titanium, zinc, vanadium, silicon, and germanium, and oxides, halides, hydroxides, alkoxides, and the like thereof, and a phthalocyanine dimer compound using an oxygen atom or the like as a crosslinking atom. In particular, X-type or ti-type metal-free phthalocyanine, A-type (also known as B-type), B-type (also known as C-type), D-type (also known as Y-type), or the like titanyl phthalocyanine (also known as oxytitanium phthalocyanine), vanadyl phthalocyanine, chloro indium phthalocyanine, hydroxy indium phthalocyanine, II-type or the like chloro gallium phthalocyanine, V-type or the like hydroxy gallium phthalocyanine, G-type, I-type, or the like p-oxogallium phthalocyanine dimer, II-type or the like p-oxoaluminum phthalocyanine dimer, and the like are preferred.

Among these phthalocyanines, A-type (also known as B-type) or B-type (also known as a-type) titanyl phthalocyanine, D-type (Y-type) titanyl phthalocyanine having a clear peak at a diffraction angle 2θ±0.2° of 27.1° or 27.3° in powder X-ray diffraction, II-type chloro gallium phthalocyanine, V-type hydroxy gallium phthalocyanine, hydroxy gallium phthalocyanine having the strongest peak at 28.1°, or having no peak at 26.2° but having a clear peak at 28.1°, and having a half width W at 25.9° satisfying 0.1°≤W≤0.4°, G-type p-oxogallium phthalocyanine dimer, and X-type metal-free phthalocyanine are particularly preferred.

A single compound of the phthalocyanine may be used, or a mixture or a mixed crystal state of multiple kinds thereof may be used. The mixture or mixed crystal state herein may be a mixture obtained by mixing the constitutional elements later, or a mixed state obtained in the production or treatment process of the phthalocyanine compound, such as synthesis, pigment formation, and crystallization. Examples of the known treatment of this type include an acid pasting treatment, a grinding treatment, and a solvent treatment. Examples of the method of forming the mixed crystal state include a method in which two kinds of crystals are mixed, then mechanically ground and formed into amorphous, and then converted to a particular crystal state through a solvent treatment, as described in JP 10-48859 A.

The particle diameter of the charge generating material is generally 1 μm or less, and preferably 0.5 μm or less.

(Binder Resin)

The binder resin used in the charge generating layer is not particularly limited. Examples thereof include a polyvinyl acetal based resin, such as a polyvinyl butyral resin, a polyvinyl formal resin, and a partially acetalized polyvinyl butyral resin in which a part of butyral is modified with formal, acetal, or the like; a polyarylate resin, a polycarbonate resin, a polyester resin, a modified ether based polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinylpyridine resin, a cellulose based resin, a polyurethane resin, an epoxy resin, a silicone resin, a polyvinyl alcohol resin, a polyvinylpyrrolidone resin, casein; a vinyl chloride-vinyl acetate based copolymer, such as a vinyl chloride-vinyl acetate copolymer, a hydroxy-modified vinyl chloride-vinyl acetate copolymer, a carboxy-modified vinyl chloride-vinyl acetate copolymer, and a vinyl chloride-vinyl acetate-maleic anhydride copolymer; a styrene-butadiene copolymer, a vinylidene chloride-acrylonitrile copolymer; an insulating resin, such as a styrene-alkyd resin, a silicone-alkyd resin, and a phenol-formaldehyde resin; and an organic photoconductive polymer, such as poly-N-vinylcarbazole, polyvinylanthracene, and polyvinylperylene. Among these resins, a polyvinyl acetal resin or a polyvinyl acetate resin are preferred from the standpoint of the dispersibility of the pigment, the adhesiveness to the conductive support or the undercoating layer, and the adhesiveness to the charge transporting layer.

One kind of the binder resin may be used alone, or two or more kinds thereof may be used in an optional combination.

(Other Components)

The charge generating layer may contain other components than the charge generating material and the binder resin depending on necessity. For example, known additives, such as an antioxidant, a plasticizer, an ultraviolet ray absorbent, an electron withdrawing compound, a leveling agent, a visible light shielding agent, and a filler, may be contained for the purpose of enhancing the film formability the flexibility the coatability the contamination resistance, the gas resistance, the light resistance, and the like.

(Mixing Ratio)

In the charge generating layer, in the case where the proportion of the charge generating material is too large, there is a concern that the stability of the coating liquid is lowered doe to the aggregation of the charge generating material and the like, whereas in the case where the proportion of the charge generating material is too small, there is a concern that the sensitivity of the photoconductor is lowered, and therefore as for the mixing ratio (mass) of the binder resin and the charge generating material, the proportion of the charge generating material is preferably 10 parts by mass or more, and particularly 30 parts by mass or more, and is preferably 1,000 parts by mass or less, and particularly 500 parts by mass or less, per 100 parts by mass of the binder resin. The proportion thereof is preferably 20 parts by mass or less, particularly 15 parts by mass or less, and more particularly 10 parts by mass or less, from the standpoint of the sensitivity.

(Layer Thickness)

The thickness of the charge generating layer is preferably 0.1 μm or more, and more preferably 0.15 μm or more, and is preferably 10 μm or less, and more preferably 0.6 μm or less.

<Charge Transporting Layer (CTL)>

It suffices that the charge transporting layer (CTL) contains a hole transporting material (HTM), the radical acceptor compound or the electron transporting material (ETM), and a binder resin.

(Hole Transporting Material (HTM))

The hole transporting material (HTM) contained in the photosensitive layer is preferably a compound having an energy difference between the HOMO level and the LUMO level of 3.60 eV or less and a HOMO level of −4.50 eV or less based on the vacuum level.

In the negatively charging photoconductor having a cured resin based protective layer (which may be referred to as a “negatively charging OCL photoconductor”), as described above, in the case where the photosensitive layer contains the particular hole transporting material (HTM), the enhancement of the ozone resistance and the strong exposure characteristics is expected, whereas a problem of deterioration of the electric characteristics may occur. It has been found that the problem can be ameliorated by subjecting the protective layer to a heat treatment immediately after curing. However, in the case where the heat treatment is performed, the site for the heat treatment process, the heating device, and the like are necessarily introduced, which results in a new problem of increase of the initial cost and increase of the running cost.

Under the circumstances, it has been found that the electric characteristics can be improved in such a manner that the radical acceptor compound or the electron transporting material (ETM) is further contained in the photosensitive layer, i.e., the radical acceptor compound or the electron transporting material (ETM) is combined with the prescribed hole transporting material (HTM) and contained in the photosensitive layer.

From this standpoint, the energy difference between the HOMO level and the LUMO level of the hole transporting material (HTM) contained in the photosensitive layer is preferably 3.60 eV or less. In particular, the energy difference is more preferably 3.50 eV or less, and further preferably 3.40 eV or less, from the standpoint of the electric characteristics. In the case where the energy difference is the upper limit value or less, the electric characteristics can be improved due to the conjugation widely spreading to provide a high hole mobility. From the standpoint of the strong exposure characteristics, the energy difference is preferably 3.10 eV or more, and more preferably 3.20 eV or more. In the case where the energy difference is the lower limit value or more, the absorption of light from a fluorescent light can be suppressed.

According to the test results having been performed by the present inventors, however, it has been found that in the case where the HOMO level of the hole transporting material (HTM) is higher than −4.50 eV based on the vacuum level, the electric characteristics are substantially not largely decreased anyway. Accordingly in the case where the hole transporting material (HTM) of this type is contained, there is no necessity of the radical acceptor compound or the electron transporting material (ETM) contained in combination.

From this standpoint, the HOMO level of the hole transporting material (HTM) contained in the photosensitive layer is preferably −4.50 eV or less, particularly −4.60 eV or less, and further particularly −4.65 eV or less, based on the vacuum level.

Examples of the compound having an energy difference between the HOMO level and the LUMO level of 3.60 eV or less, and having a HOMO level of −4.50 eV or less based on the vacuum level include a heterocyclic compound, such as a carbazole derivative, an indole derivative, an imidazole derivative, an oxazole derivative, a pyrazole derivative, a thiadiazole derivative, and a benzofuran derivative, an aniline derivative, a hydrazone derivative, an aromatic amine derivative, an arylamine derivative, a stilbene derivative, a butadiene derivative, and an enamine derivative, and a combination of multiple kinds of these compounds bonded to each other, and a polymer having a group formed of any of these compounds on the main chain or the side chain thereof.

The compound having the aforementioned energy levels (i.e., the HOMO level and the LUMO level) can be appropriately selected from the aforementioned compounds. Two or more kinds of the compounds having the aforementioned energy levels may be used in combination. A hole transporting material (HTM) that does not have the aforementioned energy levels may be contained in such a range that does not impair the effects of the present invention.

In the present invention, the HOMO energy level E_homo and the LUMO energy level E_lumo can be obtained through the stability structure by the structural optimization technique using B3LYP (see A. D. Becke, J. Chem. Phys. 98, 5648 (1993), C. Lee, et al., Phys. Rev. B37, 785 (1988), and B. Miehlich, et al., Chem. Phys. Lett., 157, 200 (1989)) as a kind of the density functional theory.

At this time, 6-31G(d,p) as 6-31G added with the polarization function is used as the basis set (see, R. Ditchfield, et al., J. Chem. Phys. 54, 724 (1971), W. J. Hehre, et al., J. Chem. Phys. 56, 2257 (1972), P. C. Hariharan, et al., Mol. Phys. 27, 209 (1974), M. S. Gordon, Chem. Phys. Lett., 76, 163 (1980), P. C. Hariharan et al., Theo. Chim. Acta, 28, 213 (1973), J.-P. Blaudeau, et al., J. Chem. Phys., 107, 5016 (1997), M. M. Francl, et al., J. Chem. Phys., 77, 3654 (1982), R. C. Binning Jr, et al., J. Comp. Chem., 11, 1206 (1990), V. A. Rassolov, et al., J. Chem. Phys., 109, 1223 (1998), and V. A. Rassolov, et al., J. Comp. Chem., 22, 976 (2001)).

In the present invention, the B3LYP calculation using 6-31G(d,p) is referred to as B3LYP/6-31G(d,p).

In the present invention, the program used for the B3LYP/6-31G(d,p) calculation is Gaussian03, Revision D.01 (M. J. Frisch, et al., Gaussian, Inc., Wallingford Conn., 2004).

The hole transporting material (HTM) is preferably a material having a high hole mobility and a compound having a triphenylamine structure is preferred from this standpoint.

Preferred examples of the hole transporting material (HTM) include compounds having any of the structures represented by the following general formulae, but are not limited thereto. Only one kind thereof may be used alone, or two or more kinds thereof may be used in an optional combination.

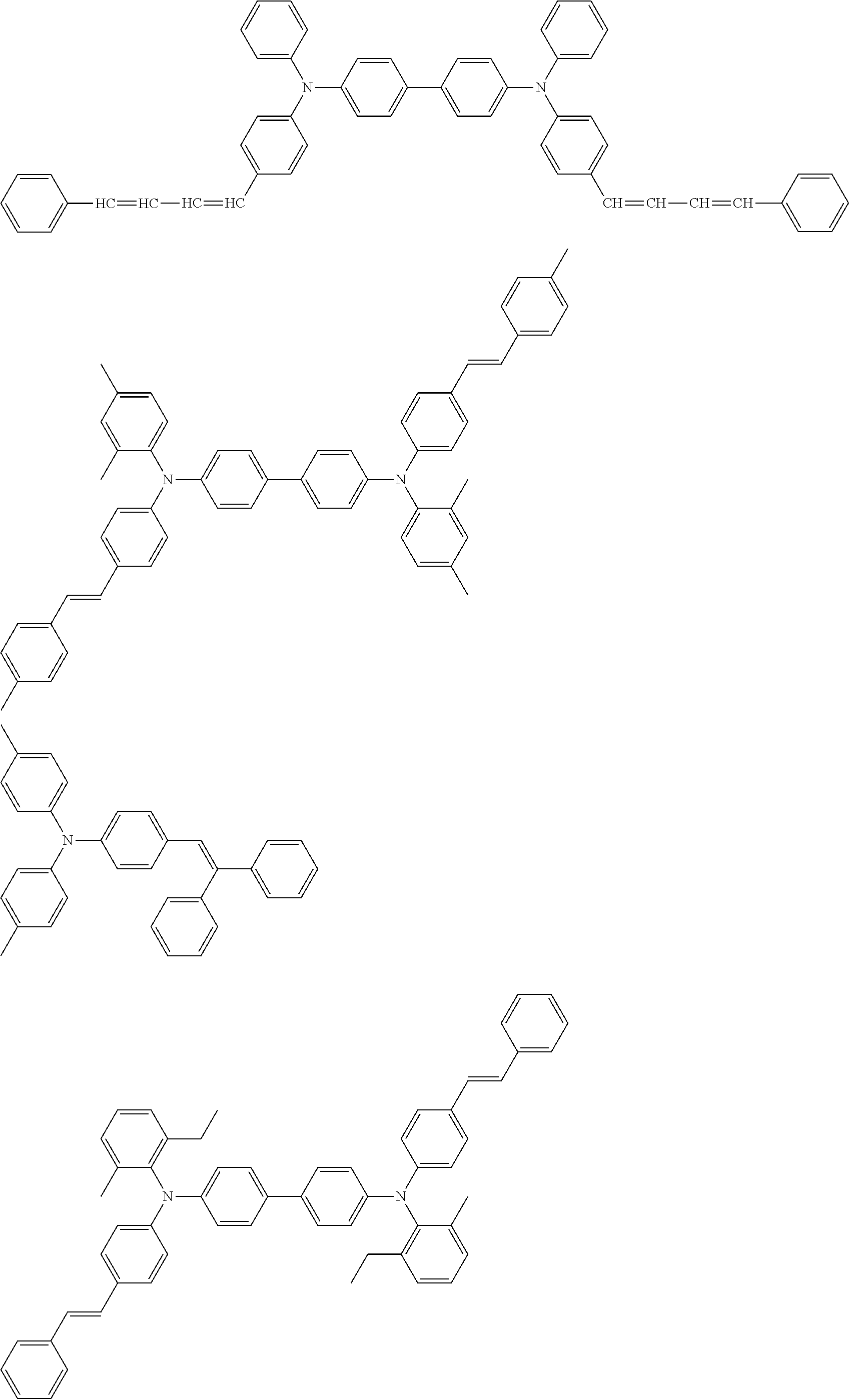

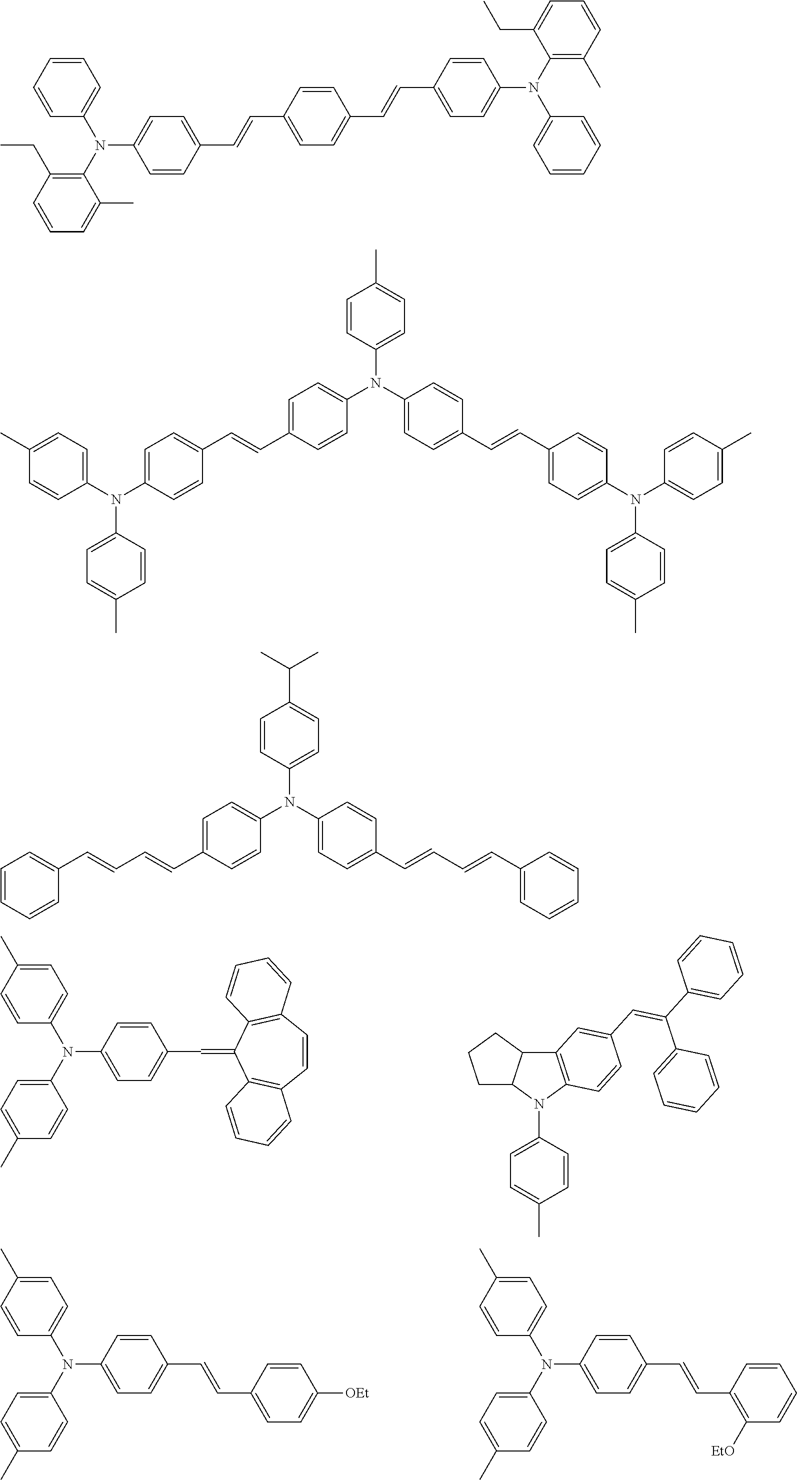

(Electron Transporting Material (ETM))

Examples of the electron transporting material (ETM) that can be used in the present photoconductor include an electron withdrawing substance, for example, an aromatic nitro compound, such as 2,4,7-trinitrofluorenone, a cyano compound, such as tetracyanoquinodimethane, and a quinone compound, such as diphenoquinone and dinaphthylquinone, and a combination of multiple kinds of these compounds bonded to each other, and a polymer having a group formed of any of these compounds on the main chain or the side chain thereof. However, there is no limitation thereto, and known electron transporting materials can be used.

Among these, the electron transporting material (ETM) is preferably a compound having a diphenoquinone structure or a dinaphthylquinone structure from the standpoint of the electric characteristics. Among these, a compound having a dinaphthylquinone structure is more preferred.

One kind of the electron transporting material may be used alone, or two or more kinds thereof may be used in an optional combination.

Specific examples of the electron transporting material (ETM) that can be used in the present photoconductor include the compounds represented by the general formulae (ET1) to (ET3) exemplified in paragraphs 0043 to 0053 of JP 2017-097065 A.

Examples thereof also include the compounds having any of the following structures.

The electron transporting material (ETM) is not limited to these examples. One kind thereof may be used alone, or two or more kinds thereof may be used in an optional combination.

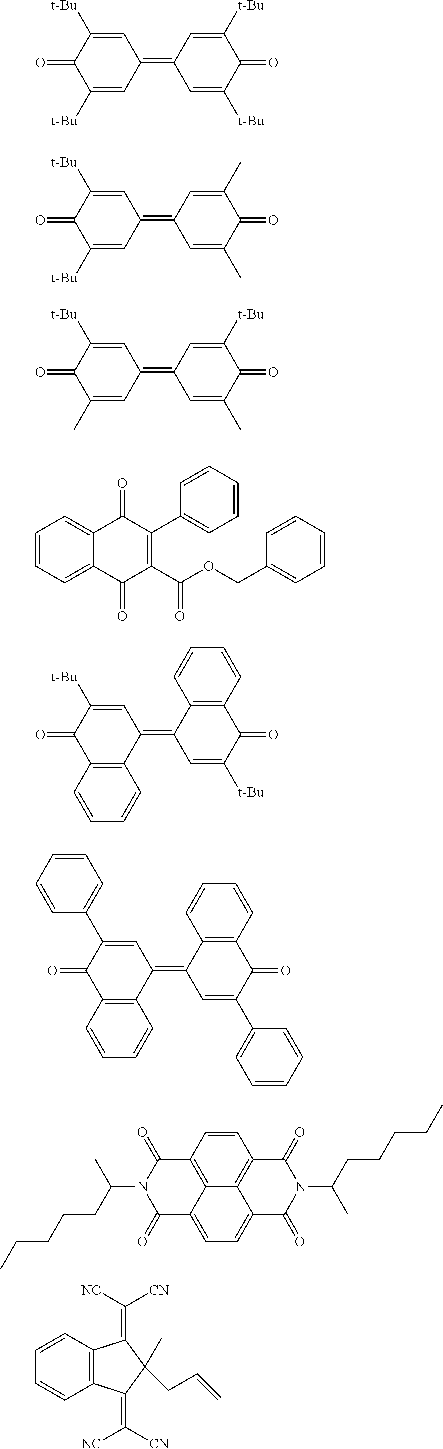

The content of the electron transporting material (ETM) in the photosensitive layer is preferably 0.1 part by mass or more, particularly preferably 0.3 part by mass or more, and further particularly preferably 0.5 part by mass or more, per 100 parts by mass of the content of the hole transporting material (HTM) in the photosensitive layer. The content thereof is preferably 10 parts by mass or less, particularly preferably 7 parts by mass or less, and further particularly preferably 5 parts by mass or less.

The content of the hole transporting material (HTM) in the photosensitive layer is preferably 10 parts by mass or more, particularly preferably 30 parts by mass or more, and further particularly preferably 50 parts by mass or more, per 1 part by mass of the electron transporting material (ETM). The content thereof is preferably 1,000 parts by mass or less, particularly 300 parts by mass or less, and further particularly preferably 100 parts by mass or less.

The content ratio of the electron transporting material (ETM) and the hole transporting material (HTM) in the photoconductor may be the same as the content ratio of the electron transporting material (ETM) and the hole transporting material (HTM) in the photosensitive layer described above.

The content ratio of the electron transporting material (ETM) and the hole transporting material (HTM) in the charge transporting layer (CTL) may be the same as the content ratio of the electron transporting material (ETM) and the hole transporting material (HTM) in the photosensitive layer described above.

(Radical Acceptor Compound)

The “radical acceptor compound” means a compound having a property capable of accepting a radical from the hole transporting material (HTM), and more specifically means a compound having an electron affinity of 3.50 eV or more.

The electron affinity herein means energy generated in incorporating one electron by the substance, and can be obtained through the stability structure by the structural optimization technique using B3LYP (see A. D. Becke, J. Chem. Phys. 98, 5648 (1993), C. Lee, et al., Phys. Rev. B37, 785 (1988), and B. Miehlich, et al., Chem. Phys. Lett., 157, 200 (1989)) as a kind of the density functional theory described above. The basis set and the program used for the calculation may be the same as described above.

As described later, in the case where the photosensitive layer contains not only the hole transporting material (HTM) but also the electron transporting material (ETM), the ETM is more likely to become a radical than the HTM, and therefore even though an HTM radical is generated, the HTM radical immediately withdraws a hydrogen atom from the ETM to convert the HTM radical to the HTM, exhibiting the effects of the present invention. In consideration of the functional mechanism, the electron transporting materials (ETM) are all encompassed in the “radical acceptor compound”, and it is considered that in the case where the “radical acceptor compound” is used instead of the electron transporting material (ETM), the effects of the present invention can be obtained by the same functional mechanism.

The electron affinity of the radical acceptor compound is preferably 3.50 eV or more, more preferably 3.70 eV or more, and further preferably 3.80 eV or more, from the standpoint of the better enjoyment of the effects of the present invention. The electron affinity of the radical acceptor compound is preferably 4.30 eV or less, more preferably 4.10 eV or less, further preferably 4.00 eV or less, and particularly preferably 3.90 eV or less.

Preferred embodiments applied to the case where the radical acceptor compound is used instead of the electron transporting material (ETM) may be the same as the preferred embodiments for the electron transporting material (ETM) described above.

The radical acceptor compound can be selected from the electron transporting materials (ETM) described above. Compounds other than exemplified for the ETM may also be used. Furthermore, a compound exemplified for the ETM and a compound other than that compound may be used in combination.

(Binder Resin)

Examples of the binder resin of the charge transporting layer include a vinyl polymer, such as polymethyl methacrylate, polystyrene, and polyvinyl chloride, and a copolymer thereof, a thermoplastic resin, such as polycarbonate, polyarylate, polyester, polyester carbonate, polysulfone, phenoxy, epoxy, and silicone, and various thermosetting compounds. Among these resins, a polycarbonate resin and a polyacrylate resin are preferred from the standpoint of the light attenuation characteristics and the mechanical strength of the photoconductor.

The viscosity average molecular weight (Mv) of the binder resin is generally in a range of 5,000 to 300,000, preferably 10,000 to 200,000, more preferably 15,000 to 150,000, and particularly preferably 20,000 to 80,000. In the case where the viscosity average molecular weight (Mv) is too small, there is a tendency that the mechanical strength of the film when the film is formed using the binder is decreased. In the case where the viscosity average molecular weight (Mv) is too large, there is a tendency that the viscosity of the coating liquid is increased to make it difficult to coat to an appropriate thickness.

As for the mixing ratio of the binder resin and the hole transporting material (HTM) constituting the photosensitive layer, the hole transporting material (HTM) is generally mixed in an amount of 20 parts by mass or more per 100 parts by mass of the binder resin. In particular, the hole transporting material (HTM) is preferably mixed in an amount of 30 parts by mass or more from the standpoint of the reduction of the residual potential, and the hole transporting material (HTM) is more preferably mixed in an amount of 40 parts by mass or more from the standpoint of the stability in repeated use and the charge mobility all per 100 parts by mass of the binder resin. The hole transporting material (HTM) is preferably mixed in an amount of 200 parts by mass or less from the standpoint of the thermal stability of the photosensitive layer, the hole transporting material (HTM) is more preferably mixed in an amount of 150 parts by mass or less from the standpoint of the compatibility of the hole transporting material (HTM) and the binder resin, and the hole transporting material (HTM) is particularly preferably mixed in an amount of 120 parts by mass or less from the standpoint of the glass transition temperature, all per 100 parts by mass of the binder resin. In the case where the hole transporting material (HTM) is mixed in an amount of 120 parts by mass or less, the glass transition temperature of the photosensitive layer is increased, and the enhancement of the leak resistance characteristics is expected.

The mixing ratio of the binder resin and the hole transporting material (HTM) constituting the charge transporting layer may be the same as the mixing ratio of the binder resin and the hole transporting material (HTM) constituting the photosensitive layer.

As for the content ratio of the hole transporting material (HTM) based on the mass of the entire photosensitive layer, the hole transporting material (HTM) is generally mixed in an amount of 16 parts by mass or more per 100 parts by mass of the photosensitive layer. In particular, the hole transporting material (HTM) is preferably mixed in an amount of 22 parts by mass or more from the standpoint of the reduction of the residual potential, and is more preferably mixed in an amount of 28 parts by mass or more from the standpoint of the stability in repeated use and the charge mobility all per 100 parts by mass of the photosensitive layer. The hole transporting material (HTM) is preferably mixed in an amount of 68 parts by mass or less from the standpoint of the thermal stability of the photosensitive layer, is more preferably mixed in an amount of 59 parts by mass or less from the standpoint of the uniformity of the photosensitive layer, and is particularly preferably mixed in an amount of 53 parts by mass or less from the standpoint of the glass transition temperature, all per 100 parts by mass of the photosensitive layer. In the case where the hole transporting material (HTM) is mixed in an amount of 53 parts by mass or less, the glass transition temperature of the photosensitive layer is increased, and the enhancement of the leak resistance characteristics is expected.

As for the mixing ratio of the binder resin and the hole transporting material (HTM) in the charge transporting layer (CTL), the hole transporting material (HTM) is preferably mixed in a ratio of 20 parts by mass or more per 100 parts by mass of the binder resin. In particular, the hole transporting material (HTM) is more preferably mixed in a ratio of 30 parts by mass or more from the standpoint of the reduction of the residual potential, and the hole transporting material (HTM) is more preferably mixed in a ratio of 40 parts by mass or more from the standpoint of the stability in repeated use and the charge mobility all per 100 parts by mass of the binder resin. The hole transporting material (HTM) is preferably mixed in a ratio of 200 parts by mass or less from the standpoint of the thermal stability of the photosensitive layer, the hole transporting material (HTM) is more preferably mixed in a ratio of 150 parts by mass or less from the standpoint of the compatibility of the hole transporting material (HTM) and the binder resin, and the hole transporting material (HTM) is particularly preferably mixed in a ratio of 120 parts by mass or less from the standpoint of the glass transition temperature, all per 100 parts by mass of the binder resin. In the case where the hole transporting material (HTM) is mixed in a ratio of 120 parts by mass or less, the glass transition temperature of the photosensitive layer is increased, and the enhancement of the leak resistance characteristics is expected.

(Other Components)

The charge transporting layer may contain other components depending on necessity in addition to the radical acceptor compound, the electron transporting material (ETM), the hole transporting material (HTM), and the binder resin. For example, known additives, such as an antioxidant, a plasticizer, an ultraviolet ray absorbent, an electron withdrawing compound, a leveling agent, a visible light shielding agent, and a filler, may be contained for enhancing the film formability, the flexibility, the coatability, the contamination resistance, the gas resistance, the light resistance, and the like.

(Layer Thickness)

The layer thickness of the charge transporting layer is not particularly limited, is preferably 5 μm or more and 50 μm or less, particularly 10 μm or more and 35 μm or less, and further particularly 15 μm or more and 25 μm or less, from the standpoint of the electric characteristics and the image stability and the standpoint of the high resolution.

<Single Layer Type Photosensitive Layer>

Examples of the single layer type photosensitive layer in the present photoconductor include a configuration including the charge generating material (CGM), the hole transporting material (HTM), and the radical acceptor compound or the electron transporting material (ETM) all existing in one layer.

The charge generating material (CGM), the hole transporting material (HTM), the radical acceptor compound, and the electron transporting material (ETM) for the single layer type photosensitive layer may be the same as those in the laminate type photosensitive layer. The contents and the content ratios thereof in the single layer type photosensitive layer may also be the same as those in the laminate type photosensitive layer.

<Formation Method of Layers>

The layers described above may be formed by repeating a coating and drying process of a coating liquid obtained by dissolving or dispersing the substances to be contained in a solvent, on the conductive support by a known method, such as dip coating, spray coating, nozzle coating, bar coating, roll coating, or blade coating, for each of the layers. There is no limitation to these formation methods.

The solvent or the dispersion medium used in the production of the coating liquid is not particularly limited. Specific examples thereof include an alcohol compound, such as methanol, ethanol, propanol, and 2-methoxyethanol; an ether compound, such as tetrahydrofuran, 1,4-dioxane, and dimethoxyethane, an ester compound, such as methyl formate and ethyl acetate, a ketone compound, such as acetone, methyl ethyl ketone, cyclohexanone, and 4-methoxy-4-methyl-2-pentanone, an aromatic hydrocarbon compound, such as benzene, toluene, and xylene, a chlorinated hydrocarbon compound, such as dichloromethane, chloroform, 1,2-dichloroethane, 1,1,2-trichloroethane, 1,1,1-trichloroethane, tetrachloroethane, 1,2-dichloropropane, and trichloroethylene, a nitrogen-containing compound, such as n-butylamine, isopropanolamine, diethylamine, triethanolamine, ethylenediamine, and triethylenediamine, and an aprotic polar solvent, such as acetonitrile, N-methylpyrrolidone, N,N-dimethylformamide, and dimethylsulfoxide. One kind thereof may be used alone, or two or more kinds thereof may be used as an optional combination and optional kinds.

The amount of the solvent or the dispersion medium used is not particularly limited, and is preferably regulated appropriately to make the solid concentration and the properties, such as the viscosity, of the coating liquid within the target ranges in consideration of the purposes of the layers and the properties of the selected solvent or dispersion medium.

The coated film is preferably dried to touch at room temperature and then dried under heating generally in a temperature range of 30° C. or more and 200° C. or less for 1 minute to 2 hours in a rest state or under an air flow. The heating temperature may be constant, or the drying may be performed by heating while changing the temperature.

<Present Protective Layer>

The present protective layer is preferably a layer containing a cured product formed by curing a curable compound.

The present protective layer may be formed with a composition containing a curable compound and a polymerization initiator. In particular, the present protective layer is preferably formed by thermal curing or photocuring a curable composition containing a curable compound and a polymerization initiator, and in particular, is more preferably formed by photocuring through irradiation of ultraviolet light and/or visible light.

(Curable Composition)

Examples of the curable composition include a composition containing a curable compound and a polymerization initiator, and depending on necessity metal oxide particles and other materials.

(Curable Compound)

The curable compound is preferably a monomer, an oligomer, or a polymer having a radical polymerizable functional group. Among these, a curable compound, particularly a photocurable compound, having crosslinkability is preferred. Examples thereof include a curable compound having two or more radical polymerizable functional groups. A compound having one radical polymerizable functional group may be used in combination.

Examples of the radical polymerizable functional group include a vinyl group, an acryloyl group, a methacryloyl group, an acryloyloxy group, a methacryloyloxy group, and an epoxy group.

Examples of the compounds preferred as the curable compound having a radical polymerizable functional group are shown below. Examples of the monomer having an acryloyl group or a methacryloyl group include trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate, glycerol triacrylate, ECH-modified glycerol triacrylate, EO-modified glycerol triacrylate, PO-modified glycerol triacrylate, tris(acryloxyethyl) isocyanurate, caprolactone-modified tris(acryloxyethyl) isocyanurate, EO-modified tris(acryloxyethyl) isocyanurate, PO-modified tris(acryloxyethyl) isocyanurate, dipentaerythritol hexaacrylate, caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate, pentaerythritol ethoxytetraacrylate, EO-modified phosphate triacrylate, 2,2,5,5-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecanedimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecanedimethanol dimethacrylate, decanediol dimethacrylate, and hexanediol dimethacrylate.

Examples of the oligomer and the polymer having an acryloyl group or a methacryloyl group include a urethane acrylate, an ester acrylate, an acrylic acrylate, and an epoxy acrylate. Among these, a urethane acrylate and an ester acrylate are preferred, and a urethane acrylate is more preferred.

These compounds may be used alone, or two or more kinds thereof may be used in combination.

(Polymerization Initiator)

The polymerization initiator includes a thermal polymerization initiator and a photopolymerization initiator.

Examples of the thermal polymerization initiator include a peroxide based compound, such as 2,5-dimethylhexane-2,5-dihydroperoxide, dicumyl peroxide, benzoyl peroxide, t-butyl peroxide, t-butylcumyl peroxide, t-butyl hydroperoxide, cumene hydroperoxide, and lauroyl peroxide, and an azo based compound, such as 2,2′-azobis(isobutyronitrile), 2,2′-azobis(2-methylbutyronitrile), 2,2′-azobis(2,4-dimethylvaleronitrile), 2,2′-azobis(cyclohexanecarbonitrile), 2,2′-azobis(methyl isobutyrate), 2,2′-azobis(isobutylamidine hydrochloride), and 4,4′-azobis-4-cyano valeric acid.

The photopolymerization initiator is classified into a direct cleavage type and a hydrogen abstraction type depending on the difference in radical generation mechanism. The photopolymerization initiator of the direct cleavage type receives light energy and a part of the covalent bonds in the molecule is cleaved to generate radicals. The photopolymerization initiator of the hydrogen abstraction type receives light energy and the molecule becoming an excitation state abstracts hydrogen from the hydrogen donor to generate radicals.

Examples of the photopolymerization initiator of the direct cleavage type include an acetophenone based or ketal based compound, such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone, a benzoin ether based compound, such as benzoin, benzoin methyl ether, benzoin ethyl ether, benzoin isobutyl ether, benzoin isopropyl ether, and O-tosylbenzoin, and an acylphosphine oxide based compound, such as diphenyl(2,4,6-trimethylbenzoyl)phosphine oxide, phenylbis(2,4,6-trimethylbenzoyl)phosphine oxide, and lithium phenyl(2,4,6-trimethylbenzoyl)phosphonate.

Examples of the photopolymerization initiator of the hydrogen abstraction type include a benzophenone based compound, such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene, and an anthraquinone based or thioxanthone based compound, such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl)oxime, an acridine based compound, a triazine based compound, and an imidazole based compound.

The photopolymerization initiator preferably has an absorption wavelength in the wavelength region of the light source used for light irradiation, for generating radicals efficiently through absorption of light energy. In the case where a component other than the photopolymerization initiator among the compounds contained in the outermost layer has absorption in this wavelength region, there are cases where the photopolymerization initiator cannot absorb sufficient energy to reduce the radical generation efficiency. The ordinary binder resin, charge transporting material, and metal oxide particles have absorption wavelengths in the ultraviolet (UV) region, and therefore this effect becomes conspicuous in the case where the light source used for light irradiation emits ultraviolet (UV) light. From the standpoint of preventing the failure, an acylphosphine oxide based compound, which has an absorption wavelength on a relatively long wavelength side among the photopolymerization initiators, is preferably contained. The acylphosphine oxide based compound is preferred since the compound has the photobleaching effect, in which the absorption wavelength region is shifted to the low wavelength side through self cleavage, so as to allow light to permeate the interior of the outermost layer, resulting in good internal curability. In this case, a hydrogen abstraction type initiator is preferably used in combination from the standpoint of supplementing the curability of the outermost layer surface.

The content ratio of the hydrogen abstraction type initiator with respect to the acylphosphine oxide based compound is not particularly limited, is preferably 0.1 part by mass or more from the standpoint of supplementing the surface curability and is preferably 5 parts by mass or less from the standpoint of retaining the internal curability all per 1 part by mass of the acylphosphine oxide based compound.

A compound having a photopolymerization acceleration effect may be used alone or as a combination with the aforementioned photopolymerization initiator. Examples thereof include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

One kind of the polymerization initiators may be used, or two or more kinds thereof may be used by mixing. The content of the polymerization initiator may be 0.5 to 40 parts by mass, and preferably 1 to 20 parts by mass, per 100 parts by mass of the total amount of the contents having radical polymerizability.

(Metal Oxide Particles)

The present protective layer may contain metal oxide particles from the standpoint of imparting a charge transporting capability and the standpoint of enhancing the mechanical strength.

The metal oxide particles used may be any type of metal oxide particles that are generally applicable to electrophotographic photoconductors. More specific examples of the metal oxide particles include metal oxide particles containing one kind of a metal element, such as titanium oxide, tin oxide, aluminum oxide, silicon oxide, zirconium oxide, zinc oxide, and iron oxide, and metal oxide particles containing multiple kinds of metal elements, such as calcium titanate, strontium titanate, and barium titanate. One kind of the metal oxide particles may be used alone, or multiple kinds of particles may be used by mixing.

Among these, metal oxide particles having a band gap that is smaller than the energy difference between the HOMO level and the LUMO level of the HTM of the photosensitive layer are preferred from the standpoint of the strong exposure characteristics. In the case where the energy difference is small, the wavelength absorbed by the hole transporting material (HTM) can be cut corresponding to the addition amount thereof, and thereby the strong exposure characteristics can be improved. From this standpoint, such metal oxide particles as titanium oxide, zinc oxide, tin oxide, calcium titanate, strontium titanate, and barium titanate are preferred. Among these, titanium oxide particles are particularly preferred.

The crystal form of titanium oxide particles may be any of rutile, anatase, brookite, and amorphous. Multiple kinds of crystal states from these crystal states may be contained.

The metal oxide particles may have a surface having been subjected to various surface treatments. For example, the surface thereof may be subjected to a treatment with an inorganic material, such as tin oxide, aluminum oxide, antimony oxide, zirconium oxide, and silicon oxide, or an organic material, such as stearic acid, a polyol, and an organic silicon compound. In the case where titanium oxide particles are used, in particular, the surface thereof is preferably treated with an organic silicon compound.

Examples of the organic silicon compound include a silicone oil, such as dimethylpolysiloxane and methyl hydrogen polysiloxane, an organosilane, such as methyldimethoxysilane and diphenyldimethoxysilane, a silazane, such as a hexamethyldisilazane, and a silane coupling agent, such as 3-methacryloyloxypropyltrimethoxysilane, 3-acryloyloxypropyltrimethoxysilane, vinyltrimethoxysilane, γ-mercaptopropyltrimethoxysilane, and γ-aminopropyltriethoxysilane. In particular, 3-methacryloyloxypropyltrimethoxysilane, 3-acryloyloxypropyltrimethoxysilane, vinyltrimethoxysilane, which have a chain polymerizable functional group, are preferred from the standpoint of enhancing the mechanical strength of the outermost layer.

The outermost surface of the surface-treated particles has been treated with the aforementioned treating agent. Before the treatment, the outermost surface may be treated with a treating agent, such as aluminum oxide, silicon oxide, and zirconium oxide.

One kind of the metal oxide particles may be used alone, or multiple kinds of the particles may be used by mixing.

The metal oxide particles used generally have an average primary particle diameter of preferably 500 nm or less, more preferably 1 to 100 nm, and further preferably 5 to 50 nm.

The average primary particle diameter can be obtained from the arithmetic average value of the diameters of the particles that are directly observed with a transmission electron microscope (which may be hereinafter referred to as TEM).

The content of the metal oxide particles in the present protective layer is not particularly limited. For example, the content thereof is preferably 10 parts by mass or more, more preferably 20 parts by mass or more, and particularly preferably 30 parts by mass or more, per 100 parts by mass of the curable compound, from the standpoint of the electric characteristics. The content thereof is preferably 300 parts by mass or less, more preferably 200 parts by mass or less, and particularly preferably 100 parts by mass or less, from the standpoint of retaining the favorable surface resistance.

(Other Materials)

The present protective layer may contain other materials depending on necessity. Examples of the other materials include a stabilizer (such as a heat stabilizer, an ultraviolet ray absorbent, a light stabilizer, and an antioxidant), a dispersant, an antistatic agent, a colorant, and a lubricant. One kind of these materials may be used alone, and two or more kinds thereof may be used in an optional ratio and an optional combination.

(Curing Method)

The curing method used may be any method of thermal curing, photocuring, electron beam curing, radiation curing, and the like, and photocuring excellent in safety and energy saving is preferred. In the photocuring, curing with metal halide light and LED light is preferred, and curing with LED light is preferred due to the controllability of the reaction and the suppression of heat generation. The wavelength of the LED light is preferably 400 nm or less, and more preferably 385 nm or less, from the standpoint of the curing rate.

(Martens Hardness)

With the present protective layer provided, the Martens hardness of the present photoconductor can be 270 N/mm² or more, particularly 300 N/mm² or more, and further particularly 330 N/mm² or more. In the case where the Martens hardness is 270 N/mm² or more, the abrasion resistance that is sufficient for practical use can be obtained.

In the present invention, the Martens hardness of the photoconductor means the Martens hardness measured on the front surface side of the photoconductor.

(Elastic Deformation Rate)

With the present protective layer provided, the elastic deformation rate of the photoconductor can be 40% or more, particularly 45% or more, and further particularly 50% or more. In the case where the elastic deformation rate is 40% or more, the abrasion resistance and the cleaning resistance that are sufficient for practical use can be obtained.

In the present invention, the elastic deformation rate of the photoconductor means the elastic deformation rate measured on the front surface side of the photoconductor.

(Formation Method of Present Protective Layer)

The present protective layer can be formed, for example, in such a manner that a curable composition containing the curable compound and the polymerization initiator, and depending on necessity the metal oxide particles and the like is dissolved in a solvent to provide a coating liquid, or dispersed in a dispersion medium to provide a coating liquid, depending on necessity, and the coating liquid is coated and then cured.

At this time, the organic solvent used for forming the present protective layer may be appropriately selected from the known organic solvents. Among these, an alcohol compound that has a low solubility to the polycarbonate and the polyarylate preferably used in the photoconductor is preferably contained.

Examples of the coating method for forming the present protective layer include a spray coating method, a spiral coating method, a ring coating method, and a dip coating method. However, the coating method is not limited to these methods.

After forming a coated film by the coating method, the coated film is preferably dried.

The curable composition may be cured through application of heat, light (such as ultraviolet light and/or visible light), radiation, or the like as external energy.

The method of applying heat energy may be performed by heating from the side of the coated layer or the side of the support with a gas, such as air and nitrogen, steam, various heat media, an infrared ray or an electromagnetic wave. The heating temperature is preferably 100° C. or more and 170° C. or less, and at the lower limit temperature or more, a sufficient reaction rate is obtained and the reaction proceeds completely. At the upper limit temperature or less, the reaction proceeds uniformly to suppress the occurrence of large distortion in the outermost layer. For performing the curing reaction uniformly it is also effective to use a method of heating to a relatively low temperature of less than 100° C., and the heating to 100° C. or more to complete the reaction.

As for the light energy, an ultraviolet (UV) radiation light source having a light emission wavelength mainly in UV light, such as a high pressure mercury lamp, a metal halide lamp, an electrodeless lamp bulb, and a light emitting diode, may be used. A visible light source may also be selected corresponding to the absorption wavelength of the curable compound and the photopolymerization initiator.

The light radiation dose is preferably 100 mJ/cm² or more, more preferably 500 mJ/cm² or more, and particularly preferably 1,000 mJ/cm² or more, from the standpoint of the curability and is preferably 20,000 mJ/cm² or less, more preferably 10,000 mJ/cm² or less, and particularly preferably 5,000 J/cm² or less, from the standpoint of the electric characteristics.

Examples of the energy of radiation include an electron beam (EB).

Among these kinds of energy light energy is preferred from the standpoint of the easiness in controlling the reaction rate, the convenience of the device, and the range of pot life.

<Conductive Support>

The conductive support is not particularly limited, as far as that the layer formed thereon can be supported, and conductivity is exhibited thereby. Examples of the conductive support mainly used include a metal material, such as aluminum, an aluminum alloy a stainless steel, copper, and nickel, a resin material having conductivity imparted with co-existing conductive powder, such as a metal, carbon, and tin oxide, and a resin, glass, paper, or the like having vapor-deposited or coated on the surface thereof a conductive material, such as aluminum, nickel, and ITO (indium oxide-tin oxide alloy). The form thereof used may be a drum form, a sheet form, a belt form, or the like. A conductive support formed of a metal material having coated thereon a conductive material having a suitable resistance value for controlling the conductivity and the surface property or for covering defects may also be used.

In the case where a metal material, such as an aluminum alloy is used as the conductive support, the metal material may be used after forming an anodized film thereon.

For example, the metal material is anodized in an acidic bath, such as chromic acid, sulfuric acid, oxalic acid, boric acid, or sulfamic acid, to form an anodized film on the surface of the metal material. In particular, the anodizing treatment in sulfuric acid may provide a better result.

In the anodizing treatment in sulfuric acid, it is preferred that the sulfuric acid concentration is generally set in a range of 100 g/L or more and 300 g/L or less, the dissolved aluminum concentration is generally set in a range of 2 g/L or more and 15 g/L or less, the liquid temperature is generally set in a range of 15° C. or more and 30° C. or less, the electrolysis voltage is generally set in a range of 10 V or more and 20 V or less, and the current density is generally set in a range of 0.5 A/dm² or more and 2 A/dm² or less, but the conditions are not limited to the above.

The average film thickness of the anodized film is generally 20 μm or less, and is particularly preferably 7 μm or less.

In the case where the anodized film is formed on the metal material, a sealing treatment is preferably performed. The sealing treatment may be performed by a known method. For example, a low temperature sealing treatment of dipping the metal material in an aqueous solution containing nickel fluoride as a major component, or a high temperature sealing treatment of dipping the metal material in an aqueous solution containing nickel acetate as a major component is preferably performed.

The surface of the conductive support may be smooth, or may be roughed by using a particular cutting method or by performing an abrasive treatment. The surface thereof may also be roughened by mixing particles having a suitable particle diameter in the material constituting the support.

An undercoating layer described later may be provided between the conductive support and the photosensitive layer for improving the adhesiveness, the blocking capability and the like.

(Undercoating Layer)

The present photoconductor may have an undercoating layer between the photosensitive layer and the conductive support.

Examples of the undercoating layer include a layer containing a resin, or a resin having particles of an organic pigment, a metal oxide, or the like dispersed therein. Examples of the organic pigment used in the undercoating layer include a phthalocyanine pigment, an azo pigment, a quinacridone pigment, an indigo pigment, a perylene pigment, a polycyclic quinone pigment, an anthanthrone pigment, and a benzimidazole pigment. Among these, a phthalocyanine pigment and an azo pigment, specifically the phthalocyanine pigment and the azo pigment used as the charge generating material, are exemplified.

Examples of the metal oxide particles used in the undercoating layer include metal oxide particles containing one kind of a metal element, such as titanium oxide, aluminum oxide, silicon oxide, zirconium oxide, zinc oxide, and iron oxide, and metal oxide particles containing multiple kinds of metal elements, such as calcium titanate, strontium titanate, and barium titanate. For the undercoating layer, only one kind of the particles may be used, or multiple kinds of the particles may be used by mixing as an optional combination at an optional ratio.

Among the metal oxide particles, titanium oxide and aluminum oxide are preferred, and titanium oxide is particularly preferred. The titanium oxide particles may have a surface that is treated with an inorganic material, such as tin oxide, aluminum oxide, antimony oxide, zirconium oxide, and silicon oxide, or an organic material, such as stearic acid, a polyol, and a silicone. The crystal form of titanium oxide particles may be any of rutile, anatase, brookite, and amorphous. Multiple kinds of crystal states from these crystal states may be contained.

The particle diameter of the metal oxide particles used in the undercoating layer is not particularly limited, is preferably 10 nm or more, and is preferably 100 nm or less, and more preferably 50 nm or less, in terms of average primary particle diameter, from the standpoint of the characteristics of the undercoating layer and the stability of the solution for forming the undercoating layer.

The undercoating layer is preferably formed in the form containing the particles dispersed in a binder resin. The binder resin used in the undercoating layer may be selected, for example, from an insulating resin, for example, a polyvinyl butyral resin, a polyvinyl formal resin, a polyvinyl acetal based resin, such as a partially acetalized polyvinyl butyral resin in which a part of butyral is modified with formal, acetal, or the like, a polyarylate resin, a polycarbonate resin, a polyester resin, a modified ether based polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinylpyridine resin, a cellulose based resin, a polyurethane resin, an epoxy resin, a silicone resin, a polyvinyl alcohol resin, a polyvinylpyrrolidone resin, casein, a vinyl chloride-vinyl acetate based copolymer, such as a vinyl chloride-vinyl acetate copolymer, a hydroxy-modified vinyl chloride-vinyl acetate copolymer, a carboxy-modified vinyl chloride-vinyl acetate copolymer, and a vinyl chloride-vinyl acetate-maleic anhydride copolymer, a styrene-butadiene copolymer, a vinylidene chloride-acrylonitrile copolymer, a styrene-alkyd resin, silicone-alkyd resin, and a phenol-formaldehyde resin, and an organic photoconductive polymer, such as poly-N-vinylcarbazole, polyvinylanthracene, and polyvinylperylene. However, the binder resin is not limited to these polymers. The binder resin may be used alone, or two or more kinds thereof may be used by mixing, and may be used after curing with a curing agent.

Among these, a polyvinyl butyral resin, a polyvinyl formal resin, a polyvinyl acetal based resin, such as a partially acetalized polyvinyl butyral resin in which a part of butyral is modified with formal, acetal, or the like, an alcohol soluble copolymer polyamide, and a modified polyamide are preferred since good dispersibility and coatability are exhibited thereby Among these, an alcohol soluble copolymer polyamide is particularly preferred.

The mixing ratio of the particles with respect to the binder resin may be optionally selected, and is preferably in a range of 10% by mass to 500% by mass from the standpoint of the stability and the coatability of the dispersion liquid.

The film thickness of the undercoating layer may be optionally selected, and is generally preferably 0.1 μm or more and 20 μm or less from the standpoint of the characteristics of the electrophotographic photoconductor and the coatability of the dispersion liquid. The undercoating layer may contain a known antioxidant and the like.

<<Present Image Formation Device>>

An image formation device (“present image formation device”) can be constituted by using the present photoconductor.

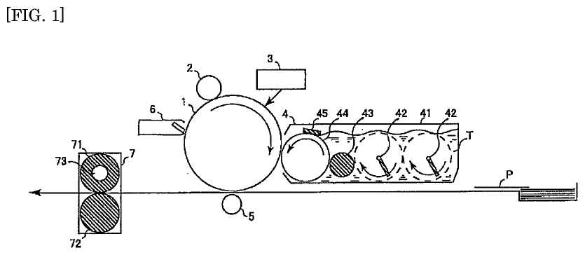

As shown in FIG. 1, the present image formation device is constituted by including the present photoconductor 1, a charging device 2, an exposing device 3, and a developing device 4, and may further include a transferring device 5, a cleaning device 6, and a fixing device 7, depending on necessity.

The present photoconductor 1 is not particularly limited, as far as the electrophotographic photoconductor of the present invention described above is used, and FIG. 1 shows, as one example thereof, a photoconductor in a drum form including a cylindrical conductive support having formed on the surface thereof the photosensitive layer described above. Along the outer peripheral surface of the present photoconductor 1, the charging device 2, the exposing device 3, the developing device 4, the transferring device 5, and the cleaning device 6 are disposed.

The charging device 2 is for charging the present photoconductor 1, and uniformly charges the surface of the present photoconductor 1 to a prescribed potential. Examples of the general charging device include a non-contact corona charging device, such as corotron and scorotron, and a contact type charging device (direct charging device) charging by bringing a charging member having a voltage applied thereto into contact with the surface of the photoconductor. Examples of the contact charging device include a charging roller and a charging brush. FIG. 1 shows a roller type charging device (charging roller) as one example of the charging device 2.

The charging roller is generally produced by molding a resin and an additive, such as a plasticizer, integrated with a metal shaft, and a laminated structure may be used depending on necessity. The voltage applied in charging may be only a direct current voltage, and an alternating current superimposed on a direct current may also be used.

The kind of the exposing device 3 is not particularly limited, as far as the exposing device exposes the present photoconductor 1 to form an electrostatic latent image on the photosensitive surface of the present photoconductor 1. Specific examples thereof include a halogen lamp, a fluorescent lamp, a laser, such as a semiconductor laser and a He—Ne laser, and an LED.

The exposure may be performed by an internal exposure system of the photoconductor. The light used in exposing may be optionally selected. For example, the exposure may be performed with monochromatic light having a wavelength of 780 nm, monochromatic light having a wavelength of 600 nm to 700 nm on the slightly short wavelength side, monochromatic light having a wavelength of 380 nm to 500 nm on the short wavelength side, or the like.

The kind of a toner T may be optionally selected, and may be a powder toner, a polymerized toner using a suspension polymerization method or an emulsion polymerization method, or the like. In the case where the polymerized toner is used, in particular, a toner having a small particle diameter of approximately 4 to 8 μm is preferred, and toner particles having various shapes including a shape close to sphere, and a bar shape deviated from sphere may be used. The polymerized toner is preferably used for enhancing the image quality since the toner is excellent in charging uniformity and transferability.

The kind of the transferring device 5 is not particularly limited, and devices of any system, for example, an electrostatic transferring method, such as corona transfer, roller transfer, and belt transfer, a pressure transferring method, an adhesive transferring method, may be used. It is assumed herein that the transferring device 5 is constituted by a transfer charger, a transfer roller, a transfer belt, or the like disposed to face the present photoconductor 1. The transferring device 5 applies a prescribed voltage value (transfer voltage) having a polarity reverse to the charging potential of the toner T, so as to transfer the toner image formed on the present photoconductor 1 to recording paper (paper or medium) P.

The cleaning device 6 is not particularly limited, and may be any cleaning device, such as a brush cleaner, a magnetic brush cleaner, an electrostatic brush cleaner, a magnetic roller cleaner, and a blade cleaner. The cleaning device 6 scrapes off the residual toner attached to the photoconductor 1 with a cleaning member, so as to recover the residual toner. However, in the case where there is only a small amount of or substantially no toner remaining on the photoconductor surface, the cleaning device 6 may be omitted.

An image is recorded in the following manner with the electrophotographic device constituted as above. Specifically, the surface (photosensitive surface) of the photoconductor 1 is charged to a prescribed potential (for example, 600 V) with the charging device 2. At this time, the photosensitive surface may be charged with a direct current voltage or may be charged by superimposing an alternating current voltage on a direct current voltage.

Subsequently the charged photosensitive surface of the photoconductor 1 is exposed with the exposing device 3 according to the image to be recorded, so as to form an electrostatic latent image on the photosensitive surface. The electrostatic latent image formed on the photosensitive surface of the photoconductor 1 is then developed with the developing device 4.

The developing device 4 thins the toner T supplied with a supplying roller 43 with a restricting member (developing blade) 45, frictionally charges the toner to the prescribed polarity (herein the positive polarity which is the same polarity as the charging potential of the photoconductor 1), conveys the toner by carrying the toner on a developing roller 44, and brings the toner into contact with the surface of the photoconductor 1.

By bringing the charged toner T carried on the developing roller 44 into contact with the surface of the photoconductor 1, a toner image corresponding to the electrostatic latent image is formed on the photosensitive surface of the photoconductor 1. The toner image is then transferred to recording paper P with the transferring device 5. Thereafter, the toner remaining on the photosensitive surface of the photoconductor 1 but not being transferred is removed with the cleaning device 6.

After transferring the toner image to the recording paper P, the toner image is thermally fixed on the recording paper P by passing through the fixing device 7, resulting in the final image.

The image formation device may include, for example, a configuration capable of performing a destaticizing step, in addition to the aforementioned configuration.

The image formation device may be constituted by further modifying, and for example, may have a configuration capable of performing steps, such as a preexposure step and an auxiliary charging step, may have a configuration performing offset printing, and may have a configuration of a full-color tandem system using multiple kinds of toners.

<<Present Electrophotographic Photoconductor Cartridge>>

The present photoconductor 1 may be combined with one component or two or more components of the charging device 2, the exposing device 3, the developing device 4, the transferring device 5, the cleaning device 6, and the fixing device 7, so as to constitute an integrated cartridge (which may be referred to as a “present electrophotographic photoconductor cartridge”).

The present electrophotographic photoconductor cartridge may be detachable to an electrophotographic device, such as a duplicator and a laser beam printer. In this case, for example, in the case where the present photoconductor 1 or another member is deteriorated, the maintenance and management of the image formation device can be facilitated in such a manner that the electrophotographic photoconductor cartridge is detached from the image formation device, and another new electrophotographic photoconductor cartridge is mounted on the image formation device.

<<Description of Terms>>

In the present invention, the expression “X to Y” (wherein X and Y each show an arbitrary numeral) encompasses not only “X or more and Y or less” but also “preferably more than X” and “preferably smaller than Y” unless otherwise indicated.

The expression “X or more” (wherein X shows an arbitrary numeral) and “Y or less” (wherein Y shows an arbitrary numeral) encompass “preferably more than X” and “preferably less than Y” respectively.

### EXAMPLES

The present invention will be further described with reference to the following examples, but the examples do not intend to limit the present invention in any way.

<Preparation of Dispersion Liquid for Forming Undercoating Layer>

[Coating Liquid for forming Under Coating Layer P1] Rutile type white titanium oxide having an average primary particle diameter of 40 nm (TTO55N, a trade name, available from Ishihara Sangyo Kaisha) and 3 parts by mass of methyldimethoxysilane per 100 parts by mass of the titanium oxide were agitated with a super mixer until the temperature in the mixer reached 160° C. with the shearing force, so as to perform the surface treatment.

Subsequently 1,000 g of a raw material slurry obtained by mixing 250 g of the surface-treated titanium oxide and 750 g of methanol was dispersed with Ultra Apex Mill (Model UAM-015), available from Kotobuki Industries Co., Ltd., having a mill capacity of approximately 0.15 L with zirconia beads having a diameter of approximately 50 μm (YTZ, available from Nikkato Corporation) as a dispersion medium, at a rotor circumferential velocity of 10 m/sec under a circulation state with a flow rate of 6 g/sec for 28 minutes, so as to produce a dispersion liquid of titanium oxide.

The dispersion liquid of titanium oxide and a copolymer polyamide solution having a compositional molar ratio of ε-caprolactam, bis(4-amino-3-methylcyclohexyl)methane, hexamethylenediamine, decamethylenedicarboxylic acid, and octadecamethylenedicarboxylic acid of 60%/15%/5%/15%/5% having been dissolved in a methanol/1-propanol/toluene mixed solvent in advance were mixed under agitation. Thereafter, the mixture was subjected to an ultrasonic dispersion treatment with an ultrasonic oscillator having a frequency of 25 kHz and an output power of 1,200 W for 1 hour. The mixture was filtered through a PTFE membrane filter having a pore diameter of 5 μm (Mitex LC, available from Advantec Group), so as to provide a coating liquid for forming an undercoating layer P1 having a mass ratio of titanium oxide/copolymer polyamide of 3/1, a mass ratio of methanol/1-propanol/toluene mixed solvent of 7/1/2, and a concentration of the solid content contained of 18%.

[Coating Liquid for forming Charge Generating Layer Q1] 10 parts of oxytitanium phthalocyanine having a powder X-ray spectrum pattern by the CuKα ray showing a characteristic peak at a Bragg angle (2θ±0.2°) of 27.3° and 5 parts of a polyvinyl acetal resin (DK31, a trade name, available from Denka Co., Ltd.) were mixed with 500 parts of 1,2-dimethoxyethane, and then subjected to a pulverization and dispersion treatment with a sand grinder mill, so as to provide a coating liquid for forming a charge generating layer Q1.

[Coating Liquid for forming Charge Transporting Layer R1] 100 parts of a polyarylate resin (viscosity average molecular weight: 43,000) represented by the following structural formula (A), 40 parts of a hole transporting material represented by the following structural formula (B), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R1 having a concentration of the solid content of 16.5%.

The structural formula (A) is as follows.

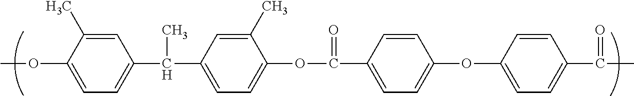

The structural formula (B) is as follows.

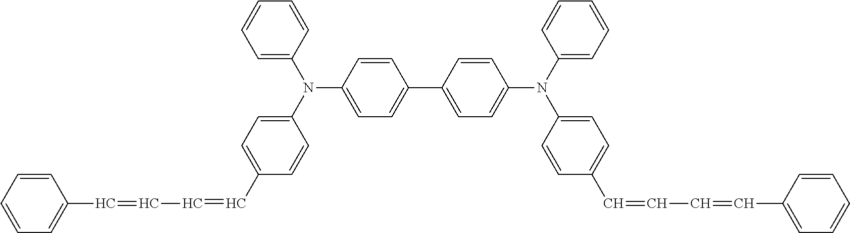 [SMILES: C(C=Cc1ccc(N(c2ccccc2)c2ccc(-c3ccc(N(c4ccccc4)c4ccc(C=CC=Cc5ccccc5)cc4)cc3)cc2)cc1)=Cc1ccccc1]

[Coating Liquid for forming Charge Transporting Layer R2] 100 parts of a polyarylate resin (viscosity average molecular weight: 43,000) represented by the structural formula (A), 40 parts of a hole transporting material represented by the structural formula (B), 1 part of an electron transporting material represented by the following structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R2 having a concentration of the solid content of 16.5%.

The electron affinity measured according to the aforementioned method for the electron transporting material represented by the following structural formula (C) was 3.83 eV.

The structural formula (C) is as follows.

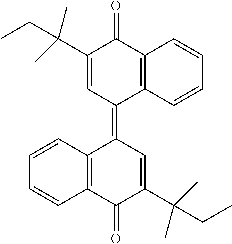 [SMILES: CCC(C)(C)C1=C/C(=C2/C=C(C(C)(C)CC)C(=O)c3ccccc32)c2ccccc2C1=O]

[Coating Liquid for forming Charge Transporting Layer R3] 100 parts of a polyarylate resin (viscosity average molecular weight: 43,000) represented by the structural formula (A), 40 parts of a hole transporting material represented by the following structural formula (D), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R3 having a concentration of the solid content of 16.5%.

The structural formula (D) is as follows.

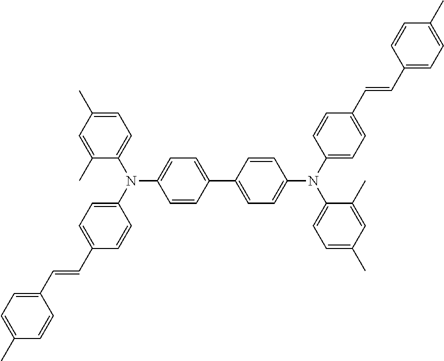 [SMILES: Cc1ccc(/C=C/c2ccc(N(c3ccc(-c4ccc(N(c5ccc(/C=C/c6ccc(C)cc6)cc5)c5ccc(C)cc5C)cc4)cc3)c3ccc(C)cc3C)cc2)cc1]

[Coating Liquid for forming Charge Transporting Layer R4] 100 parts of a polyarylate resin (viscosity average molecular weight: 43,000) represented by the structural formula (A), 40 parts of a hole transporting material represented by the structural formula (D), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R4 having a concentration of the solid content of 16.5%.

[Coating Liquid for forming Charge Transporting Layer R5] 100 parts of a polyarylate resin (viscosity average molecular weight: 43,000) represented by the structural formula (A), 60 parts of a hole transporting material represented by the following structural formula (E), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R5 having a concentration of the solid content of 18.0%.

The structural formula (E) is as follows.

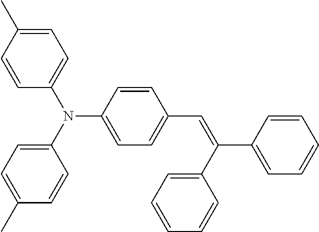 [SMILES: Cc1ccc(N(c2ccc(C)cc2)c2ccc(C=C(c3ccccc3)c3ccccc3)cc2)cc1]

[Coating Liquid for forming Charge Transporting Layer R6] 100 parts of a polyarylate resin (viscosity average molecular weight: 43,000) represented by the structural formula (A), 60 parts of a hole transporting material represented by the structural formula (E), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R6 having a concentration of the solid content of 18.1%.

[Coating Liquid for forming Charge Transporting Layer R7] 100 parts of a polyarylate resin (viscosity average molecular weight: 43,000) represented by the structural formula (A), 60 parts of a hole transporting material represented by the following structural formula (F), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R7 having a concentration of the solid content of 18.0%.

The structural formula (F) is as follows.

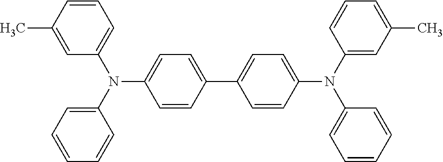

[Coating Liquid for forming Charge Transporting Layer R8] 100 parts of a polyarylate resin (viscosity average molecular weight: 43,000) represented by the structural formula (A), 60 parts of a hole transporting material represented by the structural formula (F), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R8 having a concentration of the solid content of 18.1%.

[Coating Liquid for forming Charge Transporting Layer R9] 100 parts of a polyarylate resin (viscosity average molecular weight: 43,000) represented by the structural formula (A), 40 parts of a hole transporting material represented by the following structural formula (G), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R9 having a concentration of the solid content of 16.5%.

The structural formula (G) is as follows.

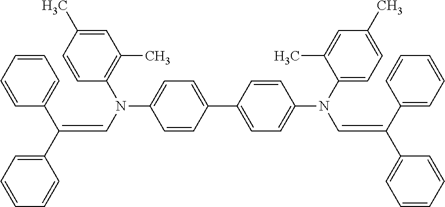 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

[Coating Liquid for forming Charge Transporting Layer R10] 100 parts of a polyarylate resin (viscosity average molecular weight: 43,000) represented by the structural formula (A), 40 parts of a hole transporting material represented by the structural formula (G), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R10 having a concentration of the solid content of 16.5%.

[Coating Liquid for forming Charge Transporting Layer R11] 100 parts of a polyarylate resin (viscosity average molecular weight: 43,000) represented by the structural formula (A), 40 parts of a hole transporting material represented by the following structural formula (H), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R11 having a concentration of the solid content of 16.5%.

The structural formula (H) is as follows.

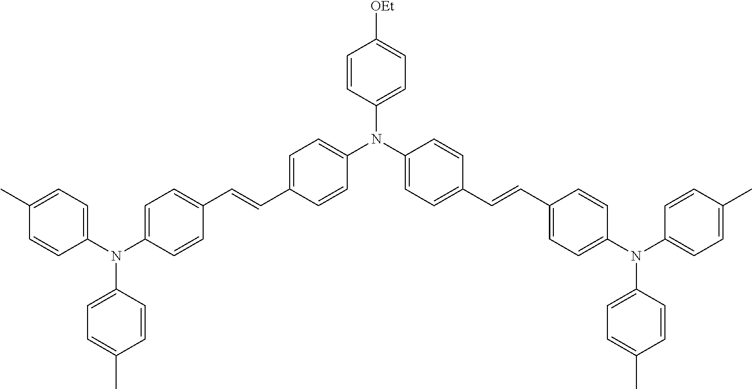

[Coating Liquid for forming Charge Transporting Layer R12] 100 parts of a polyarylate resin (viscosity average molecular weight: 43,000) represented by the structural formula (A), 40 parts of a hole transporting material represented by the structural formula (H), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R12 having a concentration of the solid content of 16.5%.

[Coating Liquid for forming Protective Layer S1] Rutile type white titanium oxide having an average primary particle diameter of 40 nm (TTO55N, a trade name, available from Ishihara Sangyo Kaisha) and 7 parts by mass of 3-methacryloxypropyltrimethoxysilane per 100 parts by mass of the titanium oxide were agitated with a super mixer until the temperature in the mixer reached 150° C. with the shearing force, so as to perform the surface treatment. Subsequently 1,000 g of a raw material slurry obtained by mixing 250 g of the surface-treated titanium oxide and 750 g of methanol was dispersed with Ultra Apex Mill (Model UAM-015), available from Kotobuki Industries Co., Ltd., having a mill capacity of approximately 0.15 L with zirconia beads having a diameter of approximately 50 μm (YTZ, available from Nikkato Corporation) as a dispersion medium, at a rotor circumferential velocity of 9 m/sec under a circulation state with a flow rate of 2.8 g/sec for 30 minutes, so as to produce a dispersion liquid of titanium oxide. A urethane acrylate oligomer (UV6300B, a trade name, available from Mitsubishi Chemical Corporation) having been dissolved in a methanol/1-propanol/toluene mixed solvent in advance, and benzophenone and Omnirad TPO H (2,4,6-trimethylbenzoyl diphenylphosphine oxide) as polymerization initiators were mixed to provide a coating liquid for forming a protective layer S1 having a ratio of UV6300B, surface-treated titania, benzophenone, and Omnirad TPO H=100/55/1/2, a solvent composition of methanol/1-propanol/toluene=7/1/2, and concentration of the solid content of 18.0%.

### Comparative Example 1

The coating liquid for forming an undercoating layer P1 was dip-coated on an aluminum cylinder having a machined surface having a diameter of 30 mm and a length of 248 mm, so as to provide an undercoating layer having a dry film thickness of 1.5 μm. The coating liquid for forming a charge generating layer Q1 was dip-coated on the undercoating layer, so as to provide a charge generating layer having a dry film thickness of 0.3 μm. The coating liquid for forming a charge transporting layer R1 was dip-coated on the charge generating layer, so as to provide a charge transporting layer having a dry film thickness of 20.0 μm. The coating liquid for forming a protective layer S1 was ring-coated on the charge transporting layer, dried at room temperature for 20 minutes, and then irradiated with a metal halide lamp at an illuminance of 140 mW/cm² for 2 minutes in a nitrogen atmosphere (oxygen content: 1% or less) while rotating the photoconductor at 60 rpm, so as to form a protective layer having a cured film thickness of 1.0 μm, and thus a negatively charging photoconductor D1 was produced.

### Example 1

A photoconductor was produced in the same manner as in the negatively charging photoconductor D1 except that the coating liquid for forming a charge transporting layer R1 was changed to the coating liquid for forming a charge transporting layer R2, and was designated as a negatively charging photoconductor D2.

### Comparative Example 2

A photoconductor was produced in the same manner as in the negatively charging photoconductor D1 except that the coating liquid for forming a charge transporting layer R1 was changed to the coating liquid for forming a charge transporting layer R3, and was designated as a negatively charging photoconductor D3.

### Example 2

A photoconductor was produced in the same manner as in the negatively charging photoconductor D1 except that the coating liquid for forming a charge transporting layer R1 was changed to the coating liquid for forming a charge transporting layer R4, and was designated as a negatively charging photoconductor D4.

### Comparative Example 3

A photoconductor was produced in the same manner as in the negatively charging photoconductor D1 except that the coating liquid for forming a charge transporting layer R1 was changed to the coating liquid for forming a charge transporting layer R5, and was designated as a negatively charging photoconductor D5.

### Example 3

A photoconductor was produced in the same manner as in the negatively charging photoconductor D1 except that the coating liquid for forming a charge transporting layer R1 was changed to the coating liquid for forming a charge transporting layer R6, and was designated as a negatively charging photoconductor D6.

### Reference Example 1

A photoconductor was produced in the same manner as in the negatively charging photoconductor D1 except that the coating liquid for forming a charge transporting layer R1 was changed to the coating liquid for forming a charge transporting layer R7, and was designated as a negatively charging photoconductor D7.

### Reference Example 2

A photoconductor was produced in the same manner as in the negatively charging photoconductor D1 except that the coating liquid for forming a charge transporting layer R1 was changed to the coating liquid for forming a charge transporting layer R8, and was designated as a negatively charging photoconductor D8.

### Reference Example 3

A photoconductor was produced in the same manner as in the negatively charging photoconductor D1 except that the coating liquid for forming a charge transporting layer R1 was changed to the coating liquid for forming a charge transporting layer R9, and was designated as a negatively charging photoconductor D9.

### Reference Example 4

A photoconductor was produced in the same manner as in the negatively charging photoconductor D1 except that the coating liquid for forming a charge transporting layer R1 was changed to the coating liquid for forming a charge transporting layer R10, and was designated as a negatively charging photoconductor D10.

### Reference Example 5

A photoconductor was produced in the same manner as in the negatively charging photoconductor D1 except that the coating liquid for forming a charge transporting layer R1 was changed to the coating liquid for forming a charge transporting layer R11, and was designated as a negatively charging photoconductor D11.

### Reference Example 6

A photoconductor was produced in the same manner as in the negatively charging photoconductor D1 except that the coating liquid for forming a charge transporting layer R1 was changed to the coating liquid for forming a charge transporting layer R12, and was designated as a negatively charging photoconductor D12.

[Energy Difference between HOMO Level and LUMO Level, and HOMO Level of Hole Transporting Material (HTM)] The HOMO levels and the energy differences of the HOMO level and the LUMO level of the hole transporting materials (HTM) used in Examples, Comparative Examples, and Reference Examples are shown in Table 1.

TABLE 1

| | HOMO | Energy difference between HOMO |
|---|---|---|
| HTM | level (−eV) | level and LUMO level (eV) |
| B | 4.66 | 3.05 |
| D | 4.58 | 3.31 |
| E | 4.68 | 3.49 |
| F | 4.69 | 3.91 |
| G | 4.60 | 3.65 |
| H | 4.35 | 3.02 |

[Evaluation of Electric Characteristics]

Subsequently, two photoconductors were produced for each of the negatively charging electrophotographic photoconductors D1 to D12, in which one photoconductor was used directly (with no heat treatment), whereas the other photoconductor was heat-treated at 125° C. for 10 minutes, and after returning the temperature of the photoconductor to room temperature, both the photoconductors each were mounted on an electrophotographic characteristics evaluation device (described in Fundamentals and Application of Electrophotographic Technology Part 2, edited by Soc. of Electrophotography of Japan, pp. 404-405, Corona Publishing Co., Ltd.) manufactured in accordance with standards set by Soc. of Electrophotography of Japan, and evaluated for the electric characteristics by the cycle process of charging (negative polarity), exposure, potential measurement, and destaticization in the following manner under an environment of 25° C. and 50%.

The photoconductor was charged to make an initial surface potential of −700 V, and after irradiating with monochromatic light of 780 nm having an intensity of 1.0 μJ/cm² obtained by filtering light from a halogen lamp with a dichroic filter, the exposed surface potential (VL) (−V) after 60 msec from the irradiation was measured. The electric characteristics are shown in Tables 2 and 3.

After the measurement of the electric characteristics, the drums each were allowed to stand under an environment of 35° C. and 85% for 24 hours, and after returning to room temperature, the aforementioned evaluation was again performed to measure the exposed surface potential (VL) (−V). The characteristics are shown in Tables 4 and 5.

TABLE 2

| | Photo- | | | VL (−V) | |
|---|---|---|---|---|---|
| | conductor | HTM | ETM | Not heated | Heated |
| Comparative | D1 | B | none | 601 | 211 |
| Example 1 | | | | | |
| Example 1 | D2 | B | C | 149 | 159 |
| Comparative | D3 | D | none | 191 | 198 |
| Example 2 | | | | | |
| Example 2 | D4 | D | C | 118 | 127 |
| Comparative | D5 | E | none | 698 | 622 |
| Example 3 | | | | | |
| Example 3 | D6 | E | C | 231 | 194 |

TABLE 3

| | Photo- | | | VL (−V) | |
|---|---|---|---|---|---|
| | conductor | HTM | ETM | Not heated | Heated |
| Reference | D7 | F | none | 167 | 178 |
| Example 1 | | | | | |
| Reference | D8 | F | C | 186 | 195 |
| Example 2 | | | | | |
| Reference | D9 | G | none | 124 | 129 |
| Example 3 | | | | | |
| Reference | D10 | G | C | 110 | 121 |
| Example 4 | | | | | |
| Reference | D11 | H | none | 93 | 111 |
| Example 5 | | | | | |
| Reference | D12 | H | C | 99 | 111 |
| Example 6 | | | | | |

TABLE 4

| | Photo- | | | VL (−V) | |
|---|---|---|---|---|---|
| | conductor | HTM | ETM | Not heated | Heated |
| Comparative | D1 | B | none | 147 | 96 |
| Example 1 | | | | | |
| Example 1 | D2 | B | C | 83 | 83 |
| Comparative | D3 | D | none | 111 | 116 |
| Example 2 | | | | | |
| Example 2 | D4 | D | C | 58 | 59 |
| Comparative | D5 | E | none | 675 | 515 |
| Example 3 | | | | | |
| Example 3 | D6 | E | C | 159 | 127 |

TABLE 5

| | Photo- | | | VL (−V) | |
|---|---|---|---|---|---|
| | conductor | HTM | ETM | Not heated | Heated |
| Reference | D7 | F | none | 108 | 120 |
| Example 1 | | | | | |
| Reference | D8 | F | C | 127 | 134 |
| Example 2 | | | | | |
| Reference | D9 | G | none | 50 | 49 |
| Example 3 | | | | | |
| Reference | D10 | G | C | 46 | 45 |
| Example 4 | | | | | |
| Reference | D11 | H | none | 39 | 40 |
| Example 5 | | | | | |
| Reference | D12 | H | C | 35 | 40 |
| Example 6 | | | | | |

[Measurement of Martens Hardness and Elastic Deformation Rate] The negatively charging photoconductors D1 to D12 (with no heat treatment) each were measured under the measurement conditions described below from the front surface side of the negatively charging photoconductor with a microhardness tester, Fischerscope HM2000, available from Helmut Fischer GmbH, under an environment of a temperature of 25° C. and a relative humidity of 50%. The Martens hardness and the elastic deformation rate of each of the specimens are shown in Tables 6 and 7.

(Measurement Condition of Martens Hardness and Elastic Deformation Rate)

Indenter: Vickers pyramid diamond indenter having angle between faces of 1360

Maximum indentation load: 0.2 mN

Loading time: 10 seconds

Unloading time: 10 seconds

The Martens hardness can be obtained by the following expression.

Martens hardness (N/mm²)=maximum indentation load/indentation area at maximum indentation load

TABLE 6

| | | | | With no heat treatment | |
|---|---|---|---|---|---|
| | | | | Martens | Elastic |
| | Photo- | | | hardness | deformation |
| | conductor | HTM | ETM | (N/mm²) | rate (%) |
| Example 1 | D2 | B | C | 311 | 46.0 |
| Example 2 | D4 | D | C | 315 | 46.3 |
| Example 3 | D6 | E | C | 340 | 48.3 |
| Comparative | D1 | B | none | 306 | 46.8 |
| Example 1 | | | | | |
| Comparative | D3 | D | none | 305 | 50.9 |
| Example 2 | | | | | |
| Comparative | D5 | E | none | 330 | 41.8 |
| Example 3 | | | | | |

TABLE 7

| | | | | With no heat treatment | |
|---|---|---|---|---|---|
| | | | | Martens | Elastic |
| | Photo- | | | hardness | deformation |
| | conductor | HTM | ETM | (N/mm²) | rate (%) |
| Reference | D7 | F | none | 303 | 41.4 |
| Example 1 | | | | | |
| Reference | D8 | F | C | 297 | 37.8 |
| Example 2 | | | | | |
| Reference | D9 | G | none | 322 | 46.6 |
| Example 3 | | | | | |
| Reference | D10 | G | C | 302 | 46.4 |
| Example 4 | | | | | |
| Reference | D11 | H | none | 311 | 50.7 |
| Example 5 | | | | | |
| Reference | D12 | H | C | 309 | 46.6 |
| Example 6 | | | | | |

[Coating Liquid for Forming Charge Transporting Layer R13]

100 parts of a polyarylate resin (viscosity average molecular weight: 43,000) represented by the structural formula (A), 75 parts of a hole transporting material represented by the structural formula (B), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R13 having a concentration of the solid content of 16.5%.

[Coating Liquid for Forming Charge Transporting Layer R14]

100 parts of a polyarylate resin (viscosity average molecular weight: 43,000) represented by the structural formula (A), 75 parts of a hole transporting material represented by the structural formula (B), 5 parts of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R14 having a concentration of the solid content of 16.5%.

[Coating Liquid for Forming Charge Transporting Layer R15]

100 parts of a polyarylate resin (viscosity average molecular weight: 43,000) represented by the structural formula (A), 75 parts of a hole transporting material represented by the structural formula (B), 5 parts of an electron transporting material represented by the following structural formula (I), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R15 having a concentration of the solid content of 16.5%.

The electron affinity measured according to the aforementioned method for the electron transporting material represented by the following structural formula (I) was 3.97 eV.

The structural formula (I) is as follows.

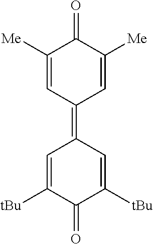 [SMILES: CC1=CC(=C2C=C(C(C)(C)C)C(=O)C(C(C)(C)C)=C2)C=C(C)C1=O]

[Coating Liquid for Forming Charge Transporting Layer R16]

100 parts of a polyarylate resin (viscosity average molecular weight: 43,000) represented by the structural formula (A), 75 parts of a hole transporting material represented by the structural formula (B), 5 parts of an electron transporting material represented by the following structural formula (J), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R16 having a concentration of the solid content of 16.5%.

The electron affinity measured according to the aforementioned method for the electron transporting material represented by the following structural formula (J) was 3.60 eV.

The structural formula (J) is as follows.

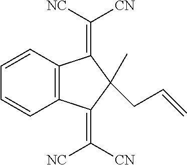 [SMILES: C=CCC1(C)C(=C(C#N)C#N)c2ccccc2C1=C(C#N)C#N]

[Coating Liquid for Forming Charge Transporting Layer R17]

100 parts of a polyarylate resin (viscosity average molecular weight: 43,000) represented by the structural formula (A), 75 parts of a hole transporting material represented by the structural formula (B), 0.2 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R17 having a concentration of the solid content of 16.5%.

[Coating Liquid for Forming Charge Transporting Layer R18]

100 parts of a polyarylate resin (viscosity average molecular weight: 43,000) represented by the structural formula (A), 75 parts of a hole transporting material represented by the structural formula (B), 0.5 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R18 having a concentration of the solid content of 16.5%.

[Coating Liquid for Forming Charge Transporting Layer R19]

100 parts of a polyarylate resin (viscosity average molecular weight: 43,000) represented by the structural formula (A), 75 parts of a hole transporting material represented by the structural formula (B), 1 part of an electron transporting material represented by the structural formula (C), 4 parts of a hindered phenol based antioxidant (Irg1076, a trade name, available from BASF SE), and 0.05 part of a silicone oil (KF-96, a trade name, available from Shin-Etsu Silicone Co., Ltd.) were dissolved and mixed under agitation in a mixed solvent of tetrahydrofuran/toluene=8/2, so as to provide a coating liquid for forming a charge transporting layer R19 having a concentration of the solid content of 16.5%.

### Comparative Example 4

The coating liquid for forming an undercoating layer P1 was dip-coated on an aluminum cylinder having a machined surface having a diameter of 30 mm and a length of 248 mm, so as to provide an undercoating layer having a dry film thickness of 1.5 μm. The coating liquid for forming a charge generating layer Q1 was dip-coated on the undercoating layer, so as to provide a charge generating layer having a dry film thickness of 0.3 μm. The coating liquid for forming a charge transporting layer R13 was dip-coated on the charge generating layer, so as to provide a charge transporting layer having a dry film thickness of 20.0 μm. The coating liquid for forming a protective layer S1 was ring-coated on the charge transporting layer, dried at room temperature for 20 minutes, and then irradiated with a metal halide lamp at an illuminance of 140 mW/cm² for 2 minutes in a nitrogen atmosphere (oxygen content: 1% or less) while rotating the photoconductor at 60 rpm, so as to form a protective layer having a cured film thickness of 3.0 μm, and thus a negatively charging photoconductor D13 was produced.

### Example 4

A photoconductor was produced in the same manner as in the negatively charging photoconductor D13 except that the coating liquid for forming a charge transporting layer R13 was changed to the coating liquid for forming a charge transporting layer R14, and was designated as a negatively charging photoconductor D14.

### Example 5

A photoconductor was produced in the same manner as in the negatively charging photoconductor D13 except that the coating liquid for forming a charge transporting layer R13 was changed to the coating liquid for forming a charge transporting layer R15, and was designated as a negatively charging photoconductor D15.

### Example 6

A photoconductor was produced in the same manner as in the negatively charging photoconductor D13 except that the coating liquid for forming a charge transporting layer R13 was changed to the coating liquid for forming a charge transporting layer R16, and was designated as a negatively charging photoconductor D16.

### Example 7

A photoconductor was produced in the same manner as in the negatively charging photoconductor D13 except that the coating liquid for forming a charge transporting layer R13 was changed to the coating liquid for forming a charge transporting layer R17, and was designated as a negatively charging photoconductor D17.

### Example 8

A photoconductor was produced in the same manner as in the negatively charging photoconductor D13 except that the coating liquid for forming a charge transporting layer R13 was changed to the coating liquid for forming a charge transporting layer R18, and was designated as a negatively charging photoconductor D18.

### Example 9

A photoconductor was produced in the same manner as in the negatively charging photoconductor D13 except that the coating liquid for forming a charge transporting layer R13 was changed to the coating liquid for forming a charge transporting layer R19, and was designated as a negatively charging photoconductor D19.

[Evaluation of Electric Characteristics]

Two photoconductors were produced for each of the negatively charging electrophotographic photoconductors D13 to D19, in which one photoconductor was used directly (with no heat treatment), whereas the other photoconductor was heat-treated at 125° C. for 10 minutes, and after returning the temperature of the photoconductor to room temperature, both the photoconductors each were evaluated for the electric characteristics according to the method described above under an environment of 25° C. and 50%. The results are shown in Table 8.

After the aforementioned evaluation, the negatively charging electrophotographic photoconductors D13 and D17 to D19 among the photoconductors each were allowed to stand under an environment of 35° C. and 85% for 24 hours, and after returning to room temperature, evaluated again in the same manner as above. The results are shown in Table 9.

TABLE 8

| | | | | Electron | Content of | VL (−V) | |
|---|---|---|---|---|---|---|---|
| | Photo- | | | affinity of | ETM (part | Not | |
| | conductor | HTM | ETM | ETM (eV) | by mass) | heated | Heated |
| Comparative | D13 | B | none | — | 0 | 316 | 94 |
| Example 4 | | | | | | | |
| Example 4 | D14 | B | C | 3.83 | 5 | 71 | 88 |
| Example 5 | D15 | B | I | 3.97 | 5 | 98 | 109 |
| Example 6 | D16 | B | J | 3.60 | 5 | 97 | 99 |
| Example 7 | D17 | B | C | 3.83 | 0.2 | 117 | 85 |
| Example 8 | D18 | B | C | 3.83 | 0.5 | 95 | 85 |
| Example 9 | D19 | B | C | 3.83 | 1 | 90 | 88 |

TABLE 9

| | | | | Electron | Content of | VL (−V) | |
|---|---|---|---|---|---|---|---|
| | Photo- | | | affinity of | ETM (part | Not | |
| | conductor | HTM | ETM | ETM (eV) | by mass) | heated | Heated |
| Comparative | D13 | B | none | — | 0 | 69 | 36 |
| Example 4 | | | | | | | |
| Example 7 | D17 | B | C | 3.83 | 0.2 | 43 | 39 |
| Example 8 | D18 | B | C | 3.83 | 0.5 | 39 | 36 |
| Example 9 | D19 | B | C | 3.83 | 1 | 40 | 39 |

(Discussion)

It was understood from the examples and the test results performed by the present inventors that in the negatively charging OCL photoconductor having a cured resin based protective layer, the electric characteristics were enhanced by using the combination of the prescribed hole transporting material (HTM) and the radical acceptor compound or the electron transporting material (ETM) contained in the photosensitive layer, even though the protective layer is not subjected to a heat treatment after curing.

In this case, it was understood that the hole transporting material (HTM) preferably has an energy difference between the HOMO level and the LUMO level of 3.60 eV or less.

It was also understood that in the case where the HOMO level of the hole transporting material (HTM) was more than −4.50 eV based on the vacuum level, and the case where the energy difference between the HOMO level and the LUMO level thereof is 3.60 eV or more, the electric characteristics were not decreased anyway. Accordingly it was understood that the necessity of the combination of the prescribed hole transporting material (HTM) and the radical acceptor compound or the electron transporting material (ETM) contained in the photosensitive layer arose only in the case where the HOMO level of the hole transporting material (HTM) was −4.50 eV or less based on the vacuum level, and simultaneously the energy difference between the HOMO level and the LUMO level thereof was 3.60 eV or less.

In the present invention, each of (1) a photosensitive layer containing a binder resin and only an HTM of the structural formula (B) satisfying the requirement of the claim 1 of the present application, (2) a photosensitive layer containing a binder resin and only an ETM of the structural formula (C), and (3) a photosensitive layer containing a binder resin, an ETM of the structural formula (C), and an HTM of the structural formula (B) was formed, and a cured resin based protective layer was formed on the photosensitive layer, which were then subjected to an ESR measurement. As a result, (1) provided a spectrum assumed to be the radical of the HTM of the structural formula (B) satisfying the requirement of the claim 1 of the present application, and (2) and (3) each provided a spectrum assumed to be the radical of the ETM of the structural formula (C). As a result, it was at least understood that the ETM was more likely to become a radical than the HTM satisfying the requirement of the claim 1 of the present application.

Based on the test results, the functional mechanism in the case where the combination of the prescribed hole transporting material (HTM) and the radical acceptor compound or the electron transporting material (ETM) is contained in the photosensitive layer can be considered as follows.

In the formation of the cured resin based protective layer, the curing generally proceeds under involvement of a radical of a polymerization initiator or the like. Accordingly the radical also spreads to the hole transporting material (HTM) of the photosensitive layer, which facilitates formation of the HTM radical. It is considered that the HTM radical functions as a trap site of charge, deteriorating the electric characteristics. It is considered that the electric characteristics are improved by heating since the HTM radical disappears through the heat treatment.

In the case where not only the hole transporting material (HTM), but the radical acceptor compound or the electron transporting material (ETM) are contained in the photosensitive layer, it is considered that even though the HTM radical is generated, the HTM radical immediately withdraws a hydrogen atom from the ETM to convert the HTM radical to the HTM since the ETM is more likely to become a radical than the HTM. On the other hand, it is considered that the ETM is converted to the ETM radical. As a result of the investigation by the present inventors, however, it is considered that this phenomenon occurs only in the case where the energy difference between the HOMO level and the LUMO level of the hole transporting material (HTM) is 3.60 eV or less, and simultaneously the HOMO level thereof is −4.50 eV or less based on the vacuum level. The mechanism thereof is estimated as follows.

In the case where the energy difference between the HOMO level and the LUMO level of the hole transporting material (HTM) is 3.60 eV or more, the HTM radical is unstable and is difficult to form. In the case where the HOMO level of the hole transporting material (HTM) is −4.50 eV or more based on the vacuum level, the original HOMO level of the HTM is shallow, and therefore even though the HTM radical is generated, the HOMO level of the HTM radical is difficult to be shallower than the original HOMO level. In the case where the HOMO level of the HTM radical and the original HOMO level of the HTM are in this relationship, the HTM radical is difficult to become a trap site of charge. Accordingly in the case where the HTM has such a nature, it is considered that the electric characteristics become good even through the ETM is not used in combination.

On the other hand, in the case where the hole transporting material (HTM) has an energy difference between the HOMO level and the LUMO level of 3.60 eV or less, and simultaneously has a HOMO level of −4.50 eV or less based on the vacuum level, the HTM radical tending to be a trap site of charge is readily generated, and a trap site is readily generated. Therefore, it is considered that the ETM is necessary for removing the generated HTM radical.

Consequently in the case where the photosensitive layer contains the hole transporting material (HTM) and the radical acceptor compound or the electron transporting material (ETM), and the hole transporting material (HTM) has an energy difference between the HOMO level and the LUMO level of 3.60 eV or less, and simultaneously has a HOMO level of −4.50 eV or less based on the vacuum level, the HTM radical adversely affecting the electric characteristics is not generated, or even though generated, is immediately changed to the ETM radical, and thus it can be considered that the electric characteristics can be improved even without a heat treatment performed.

The same tests as the aforementioned examples were performed while changing the kind of the binder resin in the photosensitive layer, and the similar results were obtained.

1. A negatively charging electrophotographic photoconductor including (i) a photosensitive layer disposed on a conductive support, and (ii) a protective layer disposed on the photosensitive layer, the protective layer containing a cured product formed by curing a curable compound,
wherein the curable compound comprises a photocurable compound,
the photosensitive layer comprises a hole transporting material (HTM),
the hole transporting material (HTM) comprises a compound having an energy difference between a HOMO level and a LUMO level of 3.60 eV or less, and having a HOMO level of −4.50 eV or less based on the vacuum level, and
the photosensitive layer further comprises a radical acceptor compound having an electron affinity of 3.50 eV or more.

2. A negatively charging electrophotographic photoconductor including (i) a photosensitive layer disposed on a conductive support, and (ii) a protective layer disposed on the photosensitive layer, the protective layer containing a cured product formed by curing a curable compound,
wherein the curable compound comprises a photocurable compound,
the photosensitive layer comprises a hole transporting material (HTM),
the hole transporting material (HTM) comprises a compound having an energy difference between a HOMO level and a LUMO level of 3.60 eV or less, and having a HOMO level of −4.50 eV or less based on the vacuum level, and
the photosensitive layer further comprises an electron transporting material (ETM).

3. The negatively charging electrophotographic photoconductor according to claim 1, wherein the photocurable compound comprises a compound having an acryloyl group.

4. The negatively charging electrophotographic photoconductor according to claim 1, wherein the protective layer comprises a layer formed with a composition containing the photocurable compound and a polymerization initiator.

5. The negatively charging electrophotographic photoconductor according to claim 1, wherein the photosensitive layer is a laminate photosensitive layer including a charge generating layer (CGL) containing a charge generating material (CGM), a charge transporting layer (CTL) disposed on the charge generating layer and containing the hole transporting material (HTM) and the radical acceptor compound or the electron transporting material (ETM).

6. The negatively charging electrophotographic photoconductor according to claim 1, wherein the negatively charging electrophotographic photoconductor has a Martens hardness of 270 N/mm² or more.

7. The negatively charging electrophotographic photoconductor according to claim 1, wherein the radical acceptor compound comprises a compound having a diphenoquinone structure.

8. The negatively charging electrophotographic photoconductor according to claim 1, wherein a content of the radical acceptor compound is 0.1 part by mass to 10 parts by mass per 100 parts by mass of the hole transporting material (HTM) in the photosensitive layer.

9. The negatively charging electrophotographic photoconductor according to claim 1, wherein the hole transporting material (HTM) comprises a compound having a triphenylamine structure.

10. The negatively charging electrophotographic photoconductor according to claim 1, wherein the protective layer further contains metal oxide particles having a band gap that is smaller than an energy difference between the HOMO level and the LUMO level of the HTM.

11. (canceled)

12. A cartridge comprising the negatively charging electrophotographic photoconductor according to claim 1.

13. An image formation device comprising the negatively charging electrophotographic photoconductor according to claim 1.

14. The negatively charging electrophotographic photoconductor according to claim 1, wherein the radical acceptor compound comprises a compound having a dinaphthylquinone structure.

15. The negatively charging electrophotographic photoconductor according to claim 2, wherein the electron transporting material (ETM) comprises a compound having a diphenoquinone structure.

16. The negatively charging electrophotographic photoconductor according to claim 2, wherein the electron transporting material (ETM) comprises a compound having a dinaphthylquinone structure.

17. The negatively charging electrophotographic photoconductor according to claim 2, wherein a content of the electron transporting material (ETM) is 0.1 part by mass to 10 parts by mass per 100 parts by mass of the hole transporting material (HTM) in the photosensitive layer.

18. The negatively charging electrophotographic photoconductor according to claim 1, wherein the photocurable compound comprises a compound having an methacryloyl group.
